(19) United States
(12) Patent Application Publication
(10) Pub. No.: US 2025/0282380 A1
(43) Pub. Date: Sep. 11, 2025

(54) PROCESSING SYSTEM AND METHOD

(71) Applicant: DENSO CORPORATION, Kariya-city (JP)

(72) Inventors: KENTO OISHI, Kariya-city (JP); ATSUSHI BABA, Kariya-city (JP)

(21) Appl. No.: 19/214,853

(22) Filed: May 21, 2025

Related U.S. Application Data
(63) Continuation of application No. PCT/JP2023/039856, filed on Nov. 6, 2023.

(30) Foreign Application Priority Data
Nov. 24, 2022 (JP) 2022-187493

(51) Int. Cl. B60W 60/00

(52) U.S. Cl. CPC B60W 60/001

(57) ABSTRACT

A processing system that executes a process related to driving of a vehicle is provided. The processing system includes: a plurality of individual evaluation units that output individual evaluation results related to a strategic guideline based on sensor data, in which at least some of output sources of the sensor data are different from each other; an integration evaluation unit that integrates each of the individual evaluation results and outputs an evaluation result after integration; and a driving planning unit that plans a driving action based on the evaluation result after integration.

### CROSS REFERENCE TO RELATED APPLICATION

The present application is a continuation application of International Patent Application No. PCT/JP2023/039856 filed on Nov. 6, 2023 which designated the U.S. and claims the benefit of priority from Japanese Patent Application No. 2022-187493 filed on Nov. 24, 2022. The entire disclosures of all of the above applications are incorporated herein by reference.

### TECHNICAL FIELD

The present disclosure relates to driving of a vehicle.

### BACKGROUND

In a related art, in order to plan a driving action, a guideline processor acquires sensor data from multiple sensors, and executes an evaluation related to a strategic guideline, based on the sensor data.

### SUMMARY

A processing system that executes a process related to driving of a vehicle is provided. The processing system includes: a plurality of individual evaluation units that output individual evaluation results related to a strategic guideline based on sensor data, in which at least some of output sources of the sensor data are different from each other; an integration evaluation unit that integrates each of the individual evaluation results and outputs an evaluation result after integration; and a driving planning unit that plans a driving action based on the evaluation result after integration.

### BRIEF DESCRIPTION OF DRAWINGS

Objects, features and advantages of the present disclosure will become more apparent from the following detailed description made with reference to the accompanying drawings. In the drawings:

FIG. 1 is a schematic diagram of a driving system;

FIG. 2 is a diagram schematically illustrating a hardware configuration of the driving system;

FIG. 3 is a hardware configuration diagram of the driving system;

FIG. 4 is a software configuration diagram of the driving system;

FIG. 5 is a diagram illustrating an example of a relationship between rules;

FIG. 6 is a diagram illustrating another example of the relationship between rules;

FIG. 7 is a diagram illustrating still another example of the relationship between rules;

FIG. 8 is a diagram illustrating an implementation example of a set of rules;

FIG. 9 is a flowchart illustrating an example of a processing method;

FIG. 10 is a diagram illustrating another implementation example of the set of rules;

FIG. 11 is a diagram illustrating still another implementation example of the set of rules;

FIG. 12 is a diagram illustrating still another implementation example of the set of rules;

FIG. 13 is a flowchart illustrating another example of a processing method; and

FIG. 14 is a diagram illustrating still another implementation example of the set of rules.

### DETAILED DESCRIPTION

Meanwhile, in a configuration in which the sensor data from all the sensors is evaluated together, it may be difficult to specify a causal relationship between an evaluation result related to the derived driving action or the strategic guideline and the multiple sensors used therefor. In particular, when the evaluation related to the strategic guideline is executed by using artificial intelligence or the like, a difficulty of this verification is significantly increased. Thus, there is room for improvement in traceability of the planned driving action.

The present disclosure provides a processing system that improves traceability of a planned driving action.

According to one aspect of the present disclosure, a processing system that executes a process related to driving of a vehicle is provided. The processing system includes: a plurality of individual evaluation units that output individual evaluation results related to a strategic guideline based on sensor data, in which at least some of output sources of the sensor data are different from each other; an integration evaluation unit that integrates each of the individual evaluation results and outputs an evaluation result after integration; and a driving planning unit that plans a driving action based on the evaluation result after integration.

According to one aspect of the present disclosure, a processing system that executes a process related to driving of a vehicle is provided. The processing system includes: a plurality of individual evaluation units that output individual evaluation results related to a strategic guideline based on sensor data, in which at least some of output sources of the sensor data are different from each other; a plurality of individual driving planning units that are provided to individually correspond to each of the individual evaluation units and that plan individual driving actions based on the individual evaluation result output by the paired individual evaluation unit; and an integration driving planning unit that integrates each of the individual driving actions and plans a driving action after integration.

According to these aspects, an evaluation related to a strategic guideline is individually executed multiple times, by making at least some of output sources of sensor data different from each other. As this process occurs, it becomes possible to analyze a causal relationship between a final driving action and a sensor with dividing into individual evaluation results. Therefore, traceability of a planned driving action can be improved.

Hereinafter, multiple embodiments will be described based on the drawings. Duplicate description may be omitted by assigning the same reference numerals to the corresponding elements in each embodiment. When only a part of a configuration is described in each embodiment, the configurations of the other embodiments described above can be applied to the other parts of the configuration. Not only the combinations of the configurations explicitly illustrated in the description of each embodiment, but also the configurations of multiple embodiments can be partially combined even in a case where they are not explicitly illustrated when there is no problem in the combination in particular.

In the following multiple embodiments, the contents of “Safety First for Automated Driving,” Tech. Rep., 2019, by Aptiv, Audi, Baidu, BMW, Continental, Daimler, FCA, here, Infineon, Intel, and Volkswagen are incorporated by reference in their entirety.

### First Embodiment

A driving system 2 according to a first embodiment realizes a function related to driving of a moving object. A part or all of the driving system 2 is mounted in the moving object. The moving object that is a target to be processed by the driving system 2 is a vehicle 1. This vehicle 1 may be referred to as an ego-vehicle, a host vehicle, or the like. The vehicle 1 may be configured to communicate with another vehicle directly or indirectly through communication infrastructure. The other vehicle is referred to as a target vehicle in some cases.

The vehicle 1 may be, for example, a road user capable of executing manual driving of an automobile or a truck. The vehicle 1 may further be capable of executing automated driving. Levels of the driving are classified in accordance with a range or the like of tasks executed by a driver, among all dynamic driving tasks (DDTs). Automated driving levels are defined in SAE J3016, for example. At Levels 0 to 2, the driver performs a part or all of the DDT. Levels 0 to 2 may be classified as so-called manual driving. Level 0 indicates that driving is not automated. Level 1 indicates that the driving system 2 assists the driver. Level 2 indicates that driving is partially automated.

At level 3 or higher, the driving system 2 performs all of the DDTs while being engaged. Levels 3 to 5 may be classified as so-called automated driving. A system capable of executing driving at level 3 or higher may be referred to as automated driving systems. A vehicle mounted with an automated driving system or capable of driving at level 3 or higher may be referred to as an automated vehicle (AV). Level 3 indicates that driving is conditionally automated. Level 4 indicates that driving is highly automated. Level 5 indicates that driving is fully automated.

The driving system 2 that is not capable of executing driving of level 3 or higher and that is capable of executing driving of at least one of levels 1 and 2 may be referred to as a driver-assistance system. In the following, when there is little need to specify the achievable level of automated driving especially, the automated driving system or driving system may be simply referred to as the driving system 2.

### (Driving System Overview)

An architecture of the driving system 2 is selected such that an efficient safety of the intended functionality (SOTIF) process can be realized. For example, the architecture of the driving system 2 may be configured based on a sense-plan-act model. The sense-plan-act model includes a sense (perception) element, a plan (planning) element, and an act (action) element as main system elements. The sense element, the plan element, and the act element interact with each other. The sense can be replaced with perception, the plan can be replaced with judgement, and the act can be replaced with control, respectively.

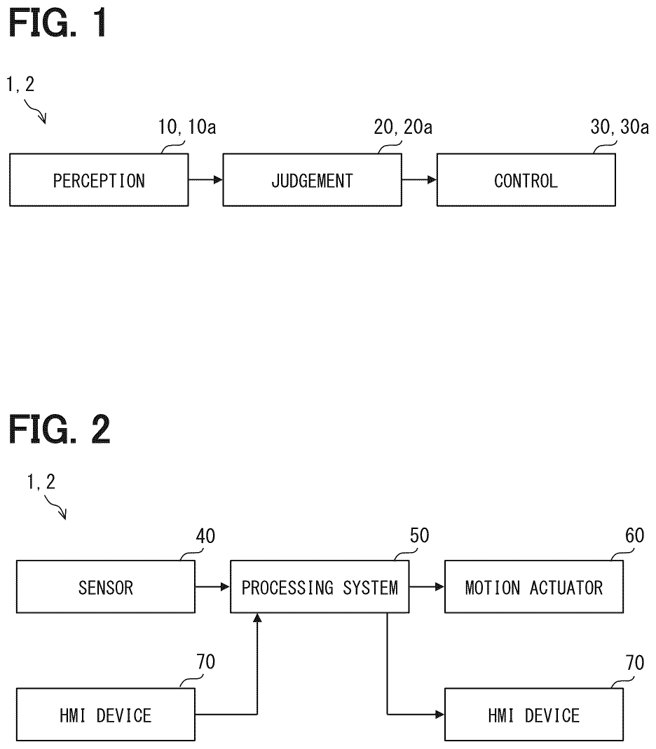

As illustrated in FIG. 1, at a function level (in other words, from a functional perspective) in such a driving system 2, a perception function, a judgement function, and a control function are implemented. As illustrated in FIG. 2, at a technical level (in other words, a technical perspective), at least multiple sensors 40 corresponding to the perception function, at least one processing system 50 corresponding to the judgement function, and multiple motion actuators 60 corresponding to the control function are implemented.

Specifically, a perception unit 10 as a functional block for realizing the perception function mainly using the multiple sensor 40, a processing system that processes detection information of the multiple sensors 40, and a processing system that generates an environment model based on the information of the multiple sensor 40 may be constructed in the driving system 2. A judgement unit 20 as a functional block for realizing the judgement function mainly using the processing system 50 may be constructed in the driving system 2. A control unit 30 as a functional block for realizing the control function mainly using the multiple motion actuators 60 and at least one processing system that outputs an operation signal of the multiple motion actuators 60 may be constructed in the driving system 2.

The perception unit 10 may be realized in a form of a perception system 10a serving as a subsystem that is provided to be distinguishable from the judgement unit 20 and the control unit 30. The judgement unit 20 may be realized in a form of a judgement system 20a serving as a subsystem provided to be distinguishable from the perception unit 10 and the control unit 30. The control unit 30 may be realized in a form of a control system 30a serving as a subsystem provided to be distinguishable from the perception unit 10 and the judgement unit 20. The perception system 10a, the judgement system 20a, and the control system 30a may constitute components that are independent of each other.

Multiple human machine interface (HMI) devices 70 may be mounted in the vehicle 1. The HMI device 70 realizes a human machine interaction, which is an interaction between an occupant (including a driver) of the vehicle 1 and the driving system 2. Some of the multiple HMI devices 70, which realize an operation input function for the occupant, may be a part of the perception unit 10. Some of the multiple HMI devices 70, which realize an information presentation function, may be a part of the control unit 30. Meanwhile, the function realized by the HMI device 70 may be provided as a function independent of the perception function, the judgement function, and the control function.

The perception unit 10 serves as the perception function including localization (for example, estimation of a position) of a road user such as the vehicle 1 and another vehicle. The perception unit 10 detects an external environment, an internal environment, and a vehicle state of the vehicle 1, and further detects a state of the driving system 2. The perception unit 10 fuses the detected information to generate an environment model. The environment model may be referred to as a world model. The judgement unit 20 derives a control action by applying a purpose and a driving policy to the environment model generated by the perception unit 10. The control unit 30 executes the control action derived by the judgement unit 20.

### (Physical Architecture Overview)

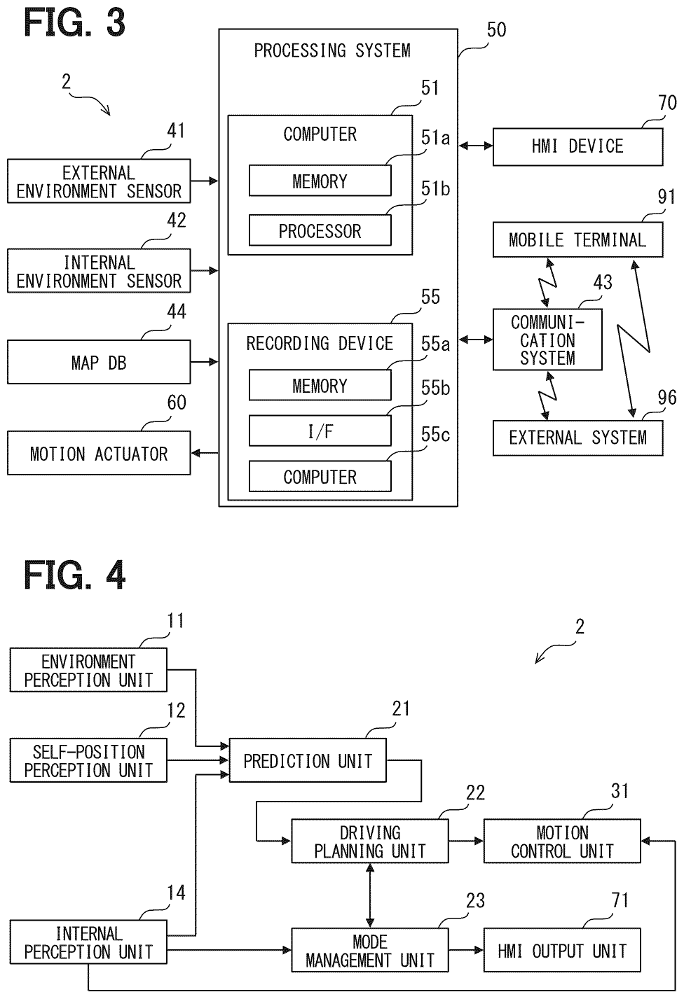

An example of a physical architecture of the driving system 2 will be described with reference to FIG. 2. The driving system 2 includes the multiple sensors 40, the multiple motion actuators 60, the multiple HMI devices 70, and at least one processing system 50. These elements can communicate with each other through one or both of a wireless connection and a wired connection. These elements may be capable of communicating with each other through, for example, an in-vehicle network such as a CAN (registered trademark). These elements are described in more detail with reference to FIG. 3.

The multiple sensors 40 include one or multiple external environment sensors 41. The multiple sensors 40 may include at least one type among one or multiple internal environment sensors 42, one or multiple communication systems 43, and a map database (DB) 44. When the sensor 40 is narrowly interpreted as indicated with the external environment sensor 41, the internal environment sensor 42, the communication system 43, and the map DB 44 may be provided as separate elements from the sensor 40 of which a perception function corresponds to the technical level.

The external environment sensor 41 may detect a target object existing in the external environment of the vehicle 1. Examples of the external environment sensor 41 having a target object detection type include a camera, a light detection and ranging/laser imaging detection and ranging (LiDAR) laser radar, a millimeter wave radar, an ultrasonic sonar, and the like. Typically, a combination of multiple types of external environment sensors 41 may be mounted to monitor each direction of a front direction, a side direction, and a rear direction of the vehicle 1.

As an example of mounting the external environment sensor 41, the ego-vehicle 1 may be mounted with multiple cameras (for example, 11 cameras) configured to respectively monitor each direction of the front direction, the front side direction, the side direction, the rear side direction, and the rear direction of the vehicle 1.

As another mounting example, multiple cameras (for example, four cameras) configured to monitor each of a front, a side, and a rear of the vehicle 1, multiple millimeter wave radars (for example, five millimeter wave radars) configured to monitor each of the front, the front side, the side, and the rear of the vehicle 1, and the LiDAR configured to monitor the front of the vehicle 1 may be mounted in the vehicle 1.

Further, the external environment sensor 41 may detect a state of an atmosphere or a state of a weather, in the external environment of the vehicle 1. The external environment sensor 41 having a state detection type is, for example, an outside air temperature sensor, a temperature sensor, a raindrop sensor, or the like.

The internal environment sensor 42 may detect a specific physical quantity (hereinafter, a motion physical quantity) related to a vehicle motion in the internal environment of the vehicle 1. Examples of the internal environment sensor 42 having a motion physical quantity detection type include a speed sensor, an acceleration sensor, a gyro sensor, and the like. The internal environment sensor 42 may detect a state of an occupant in the internal environment of the vehicle 1. The internal environment sensor 42 having an occupant detection type is, for example, an actuator sensor, a driver monitoring sensor and a system thereof, a biometric sensor, a seating sensor, an in-vehicle device sensor, or the like. In particular, examples of the actuator sensor include an accelerator sensor, a brake sensor, a steering sensor, and the like that detect an operation state of the occupant with respect to the motion actuator 60 related to motion control of the vehicle 1.

The communication system 43 acquires communication data usable in the driving system 2 through wireless communication. The communication system 43 may receive a positioning signal from an artificial satellite of a global navigation satellite system (GNSS) existing in the external environment of the vehicle 1. A communication device having a positioning type in the communication system 43 is, for example, a GNSS receiver or the like.

The communication system 43 may transmit and receive a communication signal to and from an external system 96 existing in the external environment of the vehicle 1. A communication device having a V2X type in the communication system 43 is, for example, a dedicated short range communications (DSRC) communication device, a cellular V2X (C-V2X) communication device, or the like. Examples of the communication with the V2X system existing in the external environment of the vehicle 1 include communication with a communication system of another vehicle (V2V), communication with infrastructure such as a communication device set in a traffic light or a roadside device (V21), communication with a mobile terminal of a pedestrian (V2P), communication with a network such as a cloud server (V2N), and the like. An architecture of V2X communication, including V21 communication, may adopt an architecture defined in ISO 21217, ETSI TS 102 940 to 943, IEEE 1609, and the like.

Further, the communication system 43 may transmit and receive a communication signal to and from the internal environment of the vehicle 1, for example, with a mobile terminal 91 such as a smartphone existing in the vehicle. A communication device having a terminal communication type in the communication system 43 is, for example, a Bluetooth (registered trademark) device, a Wi-Fi (registered trademark) device, an infrared communication device, or the like.

The map DB 44 is a database for storing map data usable in the driving system 2. The map DB 44 is configured with at least one type of non-transitory tangible storage medium of, for example, a semiconductor memory, a magnetic medium, an optical medium, and the like. The map DB 44 may include a database of a navigation unit that navigates a travel route of the vehicle 1 to a destination. The map DB 44 may include a database of a probe data (PD) map generated by using PD collected from each vehicle. The map DB 44 may include a database of a high definition map having a high level of definition mainly used for an automated driving system. The map DB 44 may include a database of a parking lot map including specific parking lot information, for example, parking frame information, used for automated parking or parking support.

The map DB 44 appropriate to the driving system 2 acquires and stores the latest map data through, for example, communication with a map server via the communication system 43 having a V2X type. The map data is converted into two-dimensional or three-dimensional data as data indicating the external environment of the vehicle 1. The map data may include, for example, road data representing at least one type among positional coordinates of a road structure, a shape, a road surface condition, and a standard roadway. The map data may include, for example, marking data representing at least one type of positional coordinates, a shape, and the like for a road sign, a road display, and a lane marking attached to a road. The marking data included in the map data may represent, for example, a traffic sign, an arrow marking, a lane marking, a stop line, a direction sign, a landmark beacon, a business sign, and a change in a line pattern of a road, among target objects. The map data may include structure data representing at least one type of positional coordinates, a shape, and the like of a building and a traffic light facing the road, for example. The marking data included in the map data may represent, for example, a streetlight, a road edge, a reflecting plate, a pole, and the like, among the target objects.

The motion actuator 60 is capable of controlling a vehicle motion based on an input control signal. The motion actuator 60 having a driving type is a power train including at least one type among an internal combustion engine, a drive motor, and the like. The motion actuator 60 having a braking type is, for example, a brake actuator. The motion actuator 60 having a steering type is, for example, a steering.

The HMI device 70 may be an operation input device capable of inputting an operation by a driver to transmit to the driving system 2, the will or intention of the occupant of the vehicle 1 including the driver. The HMI device 70 having an operation input type is, for example, an accelerator pedal, a brake pedal, a shift lever, a steering wheel, a turn signal lever, a mechanical switch, a touch panel such as a navigation unit, or the like. Among those, the accelerator pedal controls the power train serving as the motion actuator 60. The brake pedal controls the brake actuator serving as the motion actuator 60. The steering wheel controls a steering actuator as the motion actuator 60.

The HMI device 70 may be an information presentation device that presents information such as visual information, auditory information, cutaneous sensation information, and the like to the occupant of the vehicle 1 including the driver. The HMI device 70 having a visual information presentation type is, for example, a combination meter, a graphic meter, the navigation unit, a center information display (CID), a head-up display (HUD), an illumination unit, or the like. The HMI device 70 having an auditory information presentation type is, for example, a speaker, a buzzer, or the like. The HMI device 70 having a cutaneous information presentation type is, for example, a vibration unit of the steering wheel, a vibration unit of a seat of the driver, a reaction force unit of the steering wheel, a reaction force unit of the accelerator pedal, a reaction force unit of the brake pedal, an air conditioning unit, or the like.

The HMI device 70 may realize an HMI function in cooperation with a mobile terminal such as a smartphone by communicating with the terminal through the communication system 43. For example, the HMI device 70 may present information acquired from the smartphone to the occupant including the driver. In addition, for example, an operation input of the smartphone may be used as an alternative to an operation input to the HMI device 70.

At least one processing system 50 is provided. For example, the processing system 50 may be an integrative processing system that executes a process related to the perception function, a process related to the judgement function, and a process related to the control function in an integrated manner. In this case, the integrative processing system 50 may further execute a process related to the HMI device 70, and an HMI dedicated processing system may be separately provided. For example, the HMI dedicated processing system may be an integrated cockpit system that integrally executes a process related to each HMI device.

For example, the processing system 50 may include each of at least one processing unit corresponding to the process related to the perception function, at least one processing unit corresponding to the process related to the judgement function, and at least one processing unit corresponding to the process related to the control function.

The processing system 50 includes a communication interface for an outside, and is connected to at least one type of elements related to the process performed by the processing system 50 among the sensor 40, the motion actuator 60, the HMI device 70, and the like via at least one type among, for example, a local area network (LAN), a wire harness, an internal bus, and a wireless communication circuit.

The processing system 50 includes at least one dedicated computer 51. The processing system 50 may realize a function such as the perception function, the judgement function, and the control function by combining multiple dedicated computers 51.

For example, the dedicated computer 51 constituting the processing system 50 may be an integrated ECU that integrates a driving function of the ego-vehicle 1. The dedicated computer 51 constituting the processing system 50 may be a judgement ECU that judges a DDT. The dedicated computer 51 constituting the processing system 50 may be a monitoring ECU that monitors driving of the vehicle. The dedicated computer 51 constituting the processing system 50 may be an evaluation ECU that evaluates the driving of the vehicle. The dedicated computer 51 constituting the processing system 50 may be a navigation ECU that navigates a travel route of the ego-vehicle 1.

The dedicated computer 51 constituting the processing system 50 may be a locator ECU that estimates a position of the ego-vehicle 1. The dedicated computer 51 constituting the processing system 50 may be an image processing ECU that processes image data detected by the external environment sensor 41. The dedicated computer 51 constituting the processing system 50 may be an actuator ECU that controls the motion actuator 60 of the ego-vehicle 1. The dedicated computer 51 constituting the processing system 50 may be an HMI control unit (HCU) that integrally controls the HMI devices 70. The dedicated computer 51 constituting the processing system 50 may be at least one external computer that constructs an external center or a mobile terminal that enables communication via the communication system 43, for example.

The dedicated computer 51 constituting the processing system 50 includes at least one memory 51a and at least one processor 51b. The memory 51a may be at least one type of non-transitory tangible storage medium, such as a semiconductor memory, a magnetic medium, an optical medium, and the like, which non-temporarily stores a program, data, and the like that can be read by the processor 51b. Further, a rewritable volatile storage medium such as a random access memory (RAM) may be provided as the memory 51a. The processor 51b includes, for example, at least one type of a central processing unit (CPU), a graphics processing unit (GPU), and a reduced instruction set computer (RISC)-CPU as a core.

The dedicated computer 51 constituting the processing system 50 may be a system on a chip (SoC) in which a memory, a processor, and an interface are integrally realized on one chip, or the SoC may be provided as an element of the dedicated computer 51.

The processing system 50 may include at least one database for executing a dynamic driving task. The database may include, for example, a non-transitory tangible storage medium of at least one type of a semiconductor memory, a magnetic medium, and an optical medium, and an interface for accessing the storage medium. The database may be a scenario database (hereinafter, referred to as “scenario DB”) 59, which will be described in detail below. The database may be a rule database (hereinafter, rule DB) 58, which will be described in more detail below. At least one of the scenario DB 59 and the rule DB 58 may not be provided in the processing system 50, but may be provided in the driving system 2 independently from the other systems 10a, 20a, and 30a. At least one of the scenario DB 59 and the rule DB 58 may be provided in the external system 96 and configured to be accessible from the processing system 50 via the communication system 43.

The processing system 50 may include at least one recording device 55 for recording at least one of perception information, judgement information, and control information of the driving system 2. The recording device 55 may include at least one memory 55a and an interface 55b for writing data to the memory 55a. The memory 55a may be at least one type of non-transitory tangible storage medium among, for example, a semiconductor memory, a magnetic medium, and an optical medium.

At least one of the memories 55a may be mounted on a substrate in a form that is not easily detachable or replaceable, and in this form, for example, an embedded multi media card (eMMC) using a flash memory may be adopted. At least one of the memories 55a may be in a form that is detachable and replaceable with respect to the recording device 55, and in this form, for example, an SD card or the like may be adopted.

The recording device 55 may have a function of selecting information to be recorded from the perception information, the judgement information, and the control information. In this case, the recording device 55 may include a dedicated computer 55c. A processor provided in the recording device 55 may temporarily store information in a RAM or the like. The processor may select information to be recorded from the temporarily stored information, and store the selected information in the memory 51a.

The recording device 55 may access the memory 55a and perform recording in accordance with a data write command from the perception system 10a, the judgement system 20a, or the control system 30a. The recording device 55 may determine information flowing through an in-vehicle network, access the memory 55a, and execute recording based on judgement of a processor provided in the recording device 55.

The recording device 55 may not be provided in the processing system 50, but may be provided in the driving system 2 independently from the other systems 10a, 20a, and 30a. The recording device 55 may be provided in the external system 96, and configured to be accessible from the processing system 50 via the communication system 43.

### (Logical Architecture Overview)

Next, an example of a logical architecture of the driving system 2 will be described with reference to FIG. 4. The perception unit 10 may include an environment perception unit 11, a self-position perception unit 12, and an internal perception unit 14, as sub-blocks into which a perception function is further classified.

The environment perception unit 11 individually processes information (referred to as sensor data in some cases) related to an external environment acquired from each sensor 40, and realizes a function of perceiving the external environment including a target object, another road user, and the like. The environment perception unit 11 processes the detection data detected by each external environment sensor 41 individually. The detection data may be detection data provided from, for example, a millimeter wave radar, a sonar, or a LIDAR. The environment perception unit 11 may generate relative position data including a direction, a size, and a distance of an object with respect to the vehicle 1, from raw data detected by the external environment sensor 41.

The detection data may be image data provided from a camera, a LIDAR, or the like, for example. The environment perception unit 11 processes the image data, and extracts an object that is reflected in an angle of view of the image. The extraction of the object may include estimation of the direction, the size, and the distance of the object with respect to the vehicle 1. The extraction of the object may include, for example, classification of the object by using semantic segmentation.

Further, the environment perception unit 11 processes information acquired through a V2X function of the communication system 43. The environment perception unit 11 processes information acquired from the map DB 44.

The environment perception unit 11 may be further classified into multiple sensor perception units each optimized for one sensor group. The sensor perception unit may fuse information of one sensor group when the sensor perception unit is associated to perceive information of the one sensor group.

The self-position perception unit 12 performs localization of the vehicle 1. The self-position perception unit 12 acquires global position data of the vehicle 1 from the communication system 43 (for example, a GNSS receiver). In addition, the self-position perception unit 12 may acquire position information of the target object extracted by the environment perception unit 11. The self-position perception unit 12 acquires map information from the map DB 44. The self-position perception unit 12 integrates these pieces of information to estimate a position of the vehicle 1 on a map.

The internal perception unit 14 realizes a function of perceiving a vehicle state by processing detection data detected by each internal environment sensor 42. The vehicle state may include a state of a motion physical quantity of the vehicle 1 detected by a speed sensor, an acceleration sensor, a gyro sensor, or the like. The vehicle state may include at least one type of a state of an occupant including a driver, an operation state of the driver with respect to the motion actuator 60, and a switching state of the HMI devices 70.

The judgement unit 20 may include a prediction unit 21, a driving planning unit 22, and a mode management unit 23, as sub-blocks into which a judgement function is further classified.

The prediction unit 21 acquires external environment information perceived by the environment perception unit 11 and the self-position perception unit 12, the vehicle state perceived by the internal perception unit 14, and the like. The prediction unit 21 may interpret an environment based on the acquired information, and estimate the current situation in which the vehicle 1 is located. The situation here may be an operational situation, or may include an operational situation.

The prediction unit 21 may interpret the environment, and predict an action of an object such as another road user. The object here may be a safety-relevant object. The prediction of the action here may include at least one of prediction of a speed of the object, prediction of an acceleration of the object, and prediction of a trajectory of the object. The prediction of the action needs only be based on a reasonably predictable assumption.

The prediction unit 21 may interpret the environment, and execute judgement related to a scenario in which the vehicle 1 is currently located. The judgement related to the scenario may be selection of at least one scenario in which the vehicle 1 is currently located, from a catalog of scenarios constructed in a scenario DB 59. The prediction unit 21 may interpret the environment, or predict a potential hazard, based on the selected scenario.

The prediction unit 21 may estimate an intention of the driver, based on the predicted action, the predicted potential hazard, and the acquired vehicle state.

The driving planning unit 22 plans automated driving of the vehicle 1, based on at least one type of estimation information of the position of the vehicle 1 on the map provided by the self-position perception unit 12, prediction information and driver intention estimation information provided by the prediction unit 21, functional constraint information provided by the mode management unit 23, and the like.

The driving planning unit 22 realizes a route planning function, a behavior planning function, and a trajectory planning function. The route planning function is a function of planning at least one of a route to a destination and a lane plan at a middle distance based on the estimation information of the position of the vehicle 1 on the map. The route planning function may further include a function of determining at least one request of a lane changing request and a deceleration request based on the lane plan at the middle distance. The route planning function may be a mission and route planning function in a strategic function, or may be a function of outputting a mission plan and a route plan.

The behavior planning function is a function of planning a behavior of the vehicle 1, based on at least one of the route to the destination and the lane plan at the middle distance planned by the route planning function, the lane changing request and the deceleration request, the prediction information and the driver intention estimation information provided by the prediction unit 21, and the functional constraint information provided by the mode management unit 23. The behavior planning function may include a function of generating a condition related to a state transition of the vehicle 1. The condition related to the state transition of the vehicle 1 may correspond to a triggering condition. The behavior planning function may include a function of determining a state transition of an application that realizes a DDT, and further include a function of determining a state transition of a driving action, based on the condition. The behavior planning function may include a function of determining a constraint related to a path of the vehicle 1 in a longitudinal direction and a constraint related to the path of the vehicle 1 in a lateral direction, based on information on these state transitions. The behavior planning function may be a strategic behavior plan in a DDT function, or may output strategic behavior.

The trajectory planning function is a function of planning a travel trajectory of the vehicle 1, based on the judgement information provided by the prediction unit 21, the constraint related to the path of the vehicle 1 in the longitudinal direction, and the constraint related to the path of the vehicle 1 in the lateral direction. The trajectory planning function may include a function of generating a path plan. The path plan may include a speed plan, or the speed plan may be generated as a plan independent of the path plan. The trajectory planning function may include a function of generating multiple path plans and selecting an optimal path plan from the multiple path plans, or a function of switching between the path plans. The trajectory planning function may further include a function of generating backup data of the generated path plan. The trajectory planning function may be a trajectory planning function in the DDT function, or may output a trajectory plan.

The mode management unit 23 monitors the driving system 2, and sets a functional constraint related to driving. The mode management unit 23 may manage a mode of automated driving, for example, a state of the automated driving level. The management of the automated driving level may include switching between manual driving and automated driving, that is, permission transfer between the driver and the driving system 2, in other words, management of takeover. The mode management unit 23 may monitor a state of a subsystem related to the driving system 2, and determine a defect of the system (for example, an error, an unstable operation state, a system failure, or a failure). The mode management unit 23 may determine a mode based on the intention of the driver, based on the driver intention estimation information generated by the internal perception unit 14. The mode management unit 23 may set the functional constraint related to driving, based on at least one of a determination result of the defect of the system, a determination result of the mode, and further, the vehicle state provided by the internal perception unit 14, a sensor abnormality (or sensor failure) signal output from the sensor 40, state transition information of the application and the trajectory plan provided by the driving planning unit 22, and the like.

The mode management unit 23 may have a function of determining the constraint related to the path of the vehicle 1 in the longitudinal direction and the constraint related to the path of the vehicle 1 in the lateral direction in an integrated manner, in addition to the functional constraint related to driving. In this case, the driving planning unit 22 plans a behavior and plans a trajectory, in accordance with the constraint determined by the mode management unit 23.

The control unit 30 may include a motion control unit 31 and an HMI output unit 71, as sub-blocks into which a control function is further classified. The motion control unit 31 controls a motion of the vehicle 1, based on the trajectory plan (for example, the path plan and the speed plan) acquired from the driving planning unit 22. Specifically, the motion control unit 31 generates accelerator request information, shift request information, brake request information, and steering request information corresponding to the trajectory plan, and outputs the accelerator request information, the shift request information, the brake request information, and the steering request information to the motion actuator 60.

The motion control unit 31 is capable of directly acquiring the vehicle state, for example, at least one of a current speed, a current acceleration, and a current yaw rate of the vehicle 1, perceived by the perception unit 10 (particularly, the internal perception unit 14) from the perception unit 10, and reflecting the vehicle state on the motion control of the vehicle 1.

The HMI output unit 71 outputs information related to an HMI, based on at least one of the prediction information and the driver intention estimation information provided by the prediction unit 21, the state transition information of the application and the trajectory plan provided by the driving planning unit 22, the functional constraint information provided by the mode management unit 23, and the like. The HMI output unit 71 may manage a vehicle interaction. The HMI output unit 71 may generate a notification request based on a management state of the vehicle interaction, and control an information presentation function of the HMI devices 70. Further, the HMI output unit 71 may generate a control request for a wiper, a sensor cleaning device, a headlight, and an air conditioner based on the management state of the vehicle interaction, and control these devices.

### (Strategic Guideline)

The judgement unit 20 or the driving planning unit 22 can realize the function, in accordance with a strategic guideline based on a driving policy. A set of strategic guidelines is obtained by analyzing basic principles. The set of strategic guidelines may be implemented in the driving system 2 as one or multiple databases. The set of strategic guidelines may be a set of rules. The set of rules may be, for example, Rulebooks. A rule included in the set of rules may be defined to include a traffic law, a safety rule, an ethical rule, and a local cultural rule.

The strategic guideline is represented by the following first to fourth items. The first item is one or multiple states. The second item is one or multiple actions associated with the one or multiple states. The third item is a strategic factor associated with the state and the appropriate action. The strategic factor is, for example, a distance, speed, an acceleration, a deceleration, a direction, a time, a temperature, a season, a chemical concentration, a region, a height, or a weight. The fourth item is a deviation metric for quantitatively evaluating a deviation from the appropriate action during a machine operation. The deviation metric may be a violation metric, or may include the violation metric.

The basic principle may include laws, regulations, and the like, and may further include a combination thereof. The basic principle may include a preference that is not influenced by the laws, the regulations, and the like. The basic principle may include a motion behavior based on experience in the past. The basic principle may include a characterization of a motion environment. The basic principle may include an ethical concern.

The basic principle may also include a feedback from a human for the automated driving system. The basic principle may include at least one feedback of comfortability and predictability by a vehicle occupant and another road user. The predictability may indicate a range which is reasonably predictable. The predictability feedback may be a feedback based on the range which is reasonably predictable. The basic principle may include a rule.

The strategic guideline may include a logical relationship of clear, systematic, and comprehensive basic principles or rules for the corresponding motion behavior. The basic principle or the rule may have a quantitative measure.

### (Scenario)

In order to execute a dynamic driving task or evaluate the dynamic driving task, the driving system 2 may adopt a scenario base approach. A process necessary for executing the dynamic driving task in the automated driving is classified into a disturbance in a perception element, a disturbance in a judgement element, and a disturbance in a control element, which have different physical principles. A root cause that affects a processing result in each element is structured as a scenario structure.

The disturbance in a perception element is a perception disturbance. The perception disturbance is a disturbance indicating a state in which the perception unit 10 cannot correctly perceive a hazard due to an internal factor or an external factor of the sensor 40 and the ego-vehicle 1. The internal factor includes, for example, instability related to attachment or a manufacturing variation of a sensor such as the external environment sensor 41, an inclination of the vehicle due to a non-uniform load that changes a direction of the sensor, and shielding of the sensor due to attachment of a component to an outside of the vehicle. Examples of the external factor include fogging and stain on the sensor. The physical principle in the perception disturbance is based on a sensor mechanism of each sensor.

The disturbance in a judgement element is a traffic disturbance. The traffic disturbance is a disturbance indicating a hazardous traffic condition that occurs as a result of a combination of a geometric shape of a road, a behavior of the vehicle 1, and a position and a behavior of a surrounding vehicle. The physical principle in the traffic disturbance is based on the geometrical viewpoint and the behavior of road users.

The disturbance in a control element is a vehicle disturbance. The vehicle disturbance may be referred to as a control disturbance. The vehicle disturbance is a disturbance indicating a situation in which there is a possibility that the vehicle 1 cannot control its dynamics due to an internal factor or an external factor. Examples of the internal factor include a total weight, a weight balance, and the like of the vehicle 1. Examples of the external factor include road surface irregularity, an inclination, wind, and the like. The physical principle of the vehicle disturbance is based on a mechanical effect input to tires and a vehicle body.

In order to cope with a collision of the vehicle 1 with another road user or a structure, which is a risk in a dynamic driving task of the automated driving, a traffic disturbance scenario system in which a traffic disturbance scenario is systematized is used as a scenario structure. For the traffic disturbance scenario system, a reasonably predictable range or a reasonably predictable boundary can be defined, and an avoidable range or an avoidable boundary can be defined.

The avoidable range or the avoidable boundary can be defined, for example, by defining and modeling performance of a competent and careful human driver. The performance of the competent and careful human driver can be defined in three elements of the perception element, the judgement element, and the control element.

For example, the scenario structure may be stored in the scenario DB 59. The scenario DB 59 may store multiple scenarios including at least one of a functional scenario, a logical scenario, and a concrete scenario. The functional scenario defines a top-level qualitative scenario structure. The logical scenario is a scenario obtained by assigning a quantitative parameter range to a structured functional scenario. The concrete scenario defines a boundary of safety determination that distinguishes between a safe state and an unsafe state.

The unsafe state is, for example, a hazardous situation. A range corresponding to the safe state may be referred to as a safe range, and a range corresponding to the unsafe state may be referred to as an unsafe range. A condition that contributes to the inability to prevent, detect, and reduce hazardous behavior or reasonably predictable misuse of the vehicle 1 in a scenario may be a triggering condition.

The scenario can be classified as known or unknown, and hazardous or non-hazardous. That is, the scenario can be classified into a known hazardous scenario, a known non-hazardous scenario, an unknown hazardous scenario, and an unknown non-hazardous scenario.

### (Set of Rules)

A set of rules is a data structure that implements a structure of a degree of priority on a set of rules arranged based on their relative importance. For any specific rule in the structure of the degree of priority, a rule having a higher degree of priority is a rule having a higher importance than a rule having a lower degree of priority. The structure of the degree of priority may have one type of a hierarchical structure, a non-hierarchical structure, and a hybrid structure of a degree of priority. The hierarchical structure may be, for example, a structure indicating a pre-order for various degrees of rule violation. The non-hierarchical structure may be, for example, a weighting system for the rules. The set of rules may include a subset of rules. The subset of rules may be hierarchical.

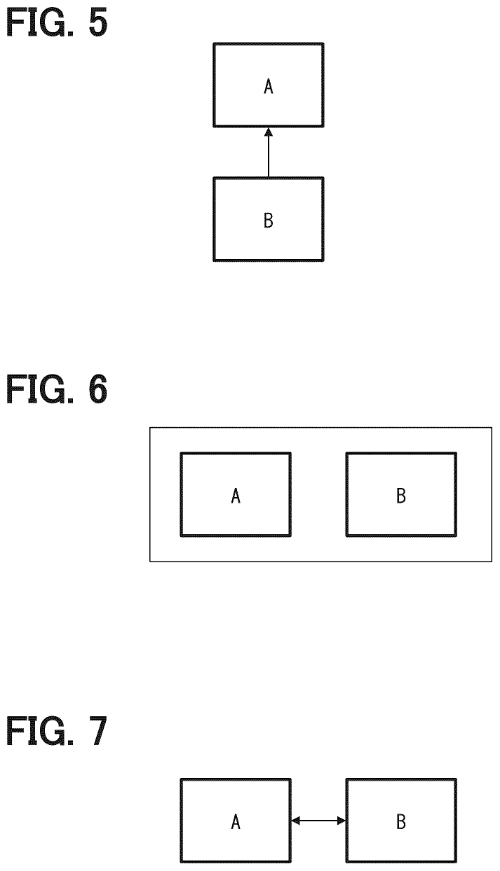

A relationship between two rules in the set of rules can be defined as illustrated by directed graphs in FIGS. 5 to 7. FIG. 5 illustrates that a rule A has an importance higher than an importance of a rule B. FIG. 6 illustrates that the rule A and the rule B cannot be compared. FIG. 7 illustrates that the rule A and the rule B have the same degree of importance.

Further, the set of rules can be customized and implemented as follows. For example, multiple rules can be integrated into one rule. Specifically, when there is a rule α that has a higher degree of priority than a rule β and a rule γ, and it is indicated that the rule β and the rule γ cannot be compared, the rule β and the rule γ may be integrated into one rule.

For example, it is possible to add another perspective and clarify a relationship between two rules of which a relationship of a degree of priority is not clearly defined. Specifically, when there is the rule α that has a higher degree of priority than the rule β and the rule γ, and a relationship between the rule β and the rule γ is not clear, it may be made clear that the rule γ has a higher degree of priority than rule β by adding another perspective.

For example, it is possible to take a new element into account by adding a rule. Specifically, when there is the rule α that has a higher degree of priority than the rule β and the rule γ, and a relationship between the rule β and the rule γ is not clear, a structure of the degree of priority can be improved by adding the rule δ that has a higher degree of priority than the rule β and the rule γ.

The set of rules may be implemented in the form described below to facilitate verification and a validity check of SOTIF.

The set of rules may have a hardware configuration independent of a module for driving planning, for example, the driving planning unit 22. For example, the set of rules may be stored in the rule DB 58 provided independently of the dedicated computer 51 that realizes the driving planning unit 22 in the processing system 50. By separating the set of rules from a black-box module such as artificial intelligence, it is possible to achieve traceability between the rules defined in the set of rules and traffic laws, and the like.

The set of rules may be implemented in a manner that facilitates verification for a known scenario. For example, a deviation or a violation metric for each rule for the known scenario may be stored, such as by the recording device 55. This makes it easier to score the judgement system 20a and performance of the driving system 2 as a whole. By separating the set of rules from the driving plan module as described above, it becomes easier to verify whether a specification of the set of rules itself is appropriate or non-appropriate.

The set of rules s may be implemented in a manner that facilitates a validity check for an unknown scenario. For example, when the vehicle 1 encounters an unknown and hazardous scenario, by decomposing a motion behavior or an actual planning process of the vehicle 1 into rules, low performance of the driving system 2 can be associated with a violation of the rules. For example, this allows rules that are difficult for the vehicle 1 to follow to be specified and fed back to the driving system 2. At least a part of the process or the verification in this feedback loop may be executed within the driving system 2 or the processing system 50, or may be executed by the external system 96 by integrating information in the external system 96.

Each rule in a set of rules is implemented such that the rule may be evaluated by using a metric, such as a deviation metric or a violation metric. These metrics may be a function of a strategic factor related to a state of a strategic guideline and/or an appropriate action. These metrics may be a weighted sum of the strategic factors. These metrics may be the strategic factor itself, or may be proportional to the strategic factor. These metrics may be inversely proportional to the strategic factor. These metrics may be a probability function of the strategic factor. These metrics may include at least one type of energy consumption, a time loss, and an economic loss.

The violation metric is a representation of futility associated with a driving action that violates a rule statement defined in the set of rules. The violation metric may be a value that uses empirical evidence to determine the degree of violation. The empirical evidence may include cloud sourcing data on reasonable judgement of a human, a driver preference, an experiment measuring a driver parameter, and a study from law enforcement or another authority.

The driving action referred to here may not be interpreted as being limited to a trajectory, and may be interpreted as being limited to the trajectory. In this case, the deviation or the violation metric includes a distance metric in a longitudinal direction and in a lateral direction. That is, when the vehicle 1 does not maintain the appropriate distance metrics in a longitudinal direction and in a lateral direction, the rule is deemed violated. The distance metric referred to here may be, or may correspond to a safety envelope, a safety distance, or the like. The distance metric may be represented as an inverse function of the distance.

### Implementation Example

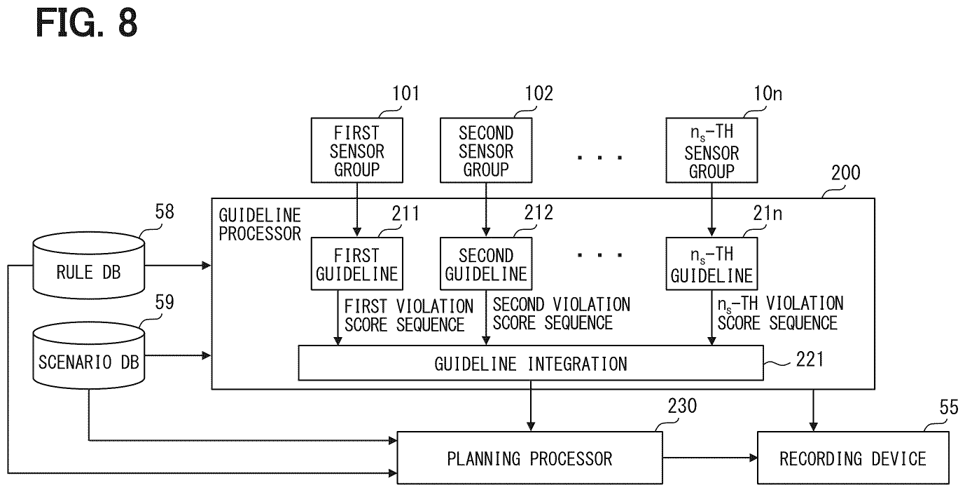

An example of implementation of a set of rules in the driving system 2 will be described in more detail below with reference to FIG. 8. In this example, the set of rules is used to pre-process a driving plan. The driving system 2 implementing the set of rules includes multiple sensor groups 101, 102, and 10n, the rule DB 58, the scenario DB 59, a guideline processor 200, and a planning processor 230. The guideline processor 200 realizes guidelines 211, 212, and 21n which correspond individually to the sensor groups 101, 102, and 10n in the same number as the sensor groups 101, 102, and 10n, and a guideline integration 221 which integrates the same number of guidelines 211, 212, and 21n, by executing a computer program.

The function realized by the guideline processor 200 may correspond to at least a part of the function of the prediction unit 21. The function realized by the planning processor 230 may correspond to at least a part of the function of the driving planning unit 22. Each of the processors 200 and 230 is a specific implementation example of the at least one processor 51b described above. Each of the processors 200 and 230 may be configured mainly from one semiconductor chip each independent. The guideline processor 200 and the planning processor 230 may be implemented on a common substrate. The guideline processor 200 and the planning processor 230 may be mounted in separate substrates.

The multiple sensor groups 101, 102, and 10n are configured by classifying the multiple sensors 40 mounted in the vehicle 1 into multiple groups. The multiple sensors 40 referred to here may include the external environment sensor 41, and may further include the communication system 43 and the map DB 44. The number of sensor groups may be any number equal to or higher than 2. Meanwhile, when the number is any odd number equal to or higher than 3, it becomes easier to perform majority voting, extract a median value, and the like in an integration process to be described below. One sensor group may include one or multiple sensors. Some sensors may be shared between the sensor groups, for example, the sensor group 101 may include sensors A and B, and the sensor group 102 may include sensors B and C.

The multiple sensor groups 101, 102, and 10n may be classified according to a type of sensor 40, according to a direction monitored by the sensor 40, or according to a coordinate system adopted (or detected) by the sensor 40. Another appropriate classification method may be adopted.

The classification according to the type is, for example, classification by type of the sensor 40. The classification by type may simplify a sensor fusion process in each of the sensor groups 101, 102, and 10n. A characteristic such as an appropriate scene and a non-appropriate scene between the sensor groups 101, 102, and 10n is clarified. Therefore, it is easy to define a policy for applying a set of rules to sensor data of each of the sensor groups 101, 102, and 10n.

In an example of classification by type, a first sensor group includes multiple cameras arranged to monitor a front, a side, and a rear of the vehicle 1, respectively. A second sensor group includes multiple millimeter wave radars arranged to monitor a front, a front side, a side, and a rear of the vehicle, respectively. A third sensor group includes LiDAR arranged to monitor a front, a side, and a rear of the vehicle 1. A fourth sensor group includes the map DB 44 and the communication system 43.

The classification according to a direction is, for example, classification according to a monitoring direction, or classification in which one sensor group covers all directions (360 degrees) around the vehicle 1. The classification by monitoring direction makes it easier to select a rule to which each guideline is applied depending on a scenario. On the other hand, when the sensors are classified such that one sensor group covers each direction around the vehicle 1, even when one sensor group stops functioning due to a failure or the like, a set of rules related to each direction can be applied to the sensor data of other sensor groups, thereby increasing redundancy.

In an example of classification by direction, the first sensor group includes a camera, a millimeter wave radar, and a LiDAR arranged to monitor a front of the vehicle 1. The second sensor group includes a camera and a millimeter wave radar arranged to monitor a side of the vehicle 1. The third sensor group includes a camera and a millimeter wave radar arranged to monitor a rear of the vehicle 1.

As an example of classification that covers all directions, the first sensor group includes a camera arranged to monitor a front of the vehicle 1, and a millimeter wave radar arranged to monitor a side and a rear of the vehicle 1. The second sensor group is a LiDAR arranged to monitor a front of the vehicle 1, and a camera configured to monitor a side and a rear of the vehicle 1. The third sensor group is configured by combining a millimeter wave radar configured to monitor a front and a front side of the vehicle 1 with the map DB 44 and a communication system 43 that can also obtain information on a rear, and the like.

Each of the sensor groups 101, 102, and 10n belongs to the perception system 10a, and realizes the function of the perception unit 10. Each of the sensor groups 101, 102, and 10n outputs sensor data to the guidelines 211, 212, and 21n respectively paired with the sensor groups 101, 102, and 10n. That is, different sensor data from different output sources are input to each of the guidelines 211, 212, and 21n.

Each of the guidelines 211, 212, and 21n is an evaluator that evaluates a rule, based on the sensor data from the sensor groups 101, 102, and 10n respectively paired with the guidelines 211, 212, and 21n, a set of rules stored in the rule DB 58, and scenario data stored in the scenario DB 59. The guidelines 211, 212, and 21n are configured to execute a process according to a strategic guideline. The guidelines 211, 212, and 21n referred to here may refer to guidelines for a driving action.

The rule DB 58 stores a set of rules in a form that can be read by the processor 200 by a computer program that realizes each of the guidelines 211, 212, and 21n.

The scenario DB 59 stores a scenario structure in a form that can be read by the processor 200 by the computer program in each of the guidelines 211, 212, and 21n. Each of the guidelines 211, 212, and 21n may perceive an environment in which the vehicle 1 is located, based on the sensor data input from the sensor groups 101, 102, and 10n respectively paired with the guidelines 211, 212, and 21n. In the perceiving of the environment, each of the guidelines 211, 212, and 21n may refer to a scenario structure, and select a scenario which the vehicle 1 is encountering. The scenario selected may be one scenario or a combination of multiple scenarios. Each of the guidelines 211, 212, and 21n may select a different scenario in parallel to proceed with the process.

Each of the guidelines 211, 212, and 21n may specify a known hazardous scenario, a known non-hazardous scenario, an unknown hazardous scenario, and an unknown non-hazardous scenario in the selecting of the scenario. Each of the guidelines 211, 212, and 21n may evaluate a rule by referencing a scenario structure, and selecting and specifying a scenario. For example, in the known hazardous scenario, a rule associated with the risk factor is to be evaluated negatively (as violated).

The first guideline 211 calculates a first violation score sequence, by using the first sensor group 101, for a rule sequence corresponding to a set of rules. The second guideline 212 calculates a second violation score sequence, by using the second sensor group 102, for the rule sequence corresponding to the set of rules. The k-th guideline calculates a k-th violation score sequence, by using a k-th sensor group, for the rule sequence corresponding to the set of rules. The nₛ-th guideline 21n calculates an nₛ-th violation score sequence, by using an nₛ-th sensor group 10n, for the rule sequence corresponding to the set of rules. Here, nₛ is the total number of sensor groups. Note that k=1, 2, . . . , and nₛ.

The rule sequence is represented, for example, by the following Expression 1.

$$\{ {r}_{1} , … , {r}_{{n}_{r}} \} \qquad ( Expression 1 )$$

Here, nᵣ is the total number of rules stored in the set of rules. When the same rule is evaluated between the respective guidelines 211, 212, and 21n, the rule sequence may be represented as a matrix having 1 row and nᵣ columns, as indicated in Expression 1. Alternatively, when evaluating rules that differ partially between the respective guidelines 211, 212, and 21n, the rule sequence may be represented as a matrix having nₛ rows and nᵣ columns. A concept of a matrix here is understood to include configurations of one row and multiple columns, and multiple rows and one column. When simply described as a column, it is to be understood to include a matrix of one row and multiple columns as well as a configuration of multiple rows and multiple columns.

The violation score sequence which the k-th guideline outputs to the guideline integration 221 is represented by, for example, the following Expression 2.

$${ρ}_{k} = \{ {ϱ}_{k , 1} , … , {ϱ}_{k , {n}_{r}} \} \qquad ( Expression 2 )$$

The violation score sequence is data in which a violation score for each rule is organized into a matrix. The violation score sequence can be said to be data in which values of the violation metrics are arranged in a matrix, that is, a matrix of violation metrics. The violation score is represented as a numerical value indicating an evaluation result of the rule. The violation score is 0 when the rule is fully complied with. The violation score is 1 when the rule is completely violated. Each guideline may be configured to output either 0 or 1 as the violation score, or may be configured to output any value in a range from 0 to 1. For example, an intermediate value such as 0.5 may be output as the violation score. For example, the intermediate value may mean that it is impossible to judge whether a rule is violated due to a decrease in reliability or lack of sensor data. For example, the intermediate value may represent a provisional evaluation result of the rule for an unknown scenario that is not adequately addressed by the current guideline specification. The violation score may be an example of a specific implementation of a deviation metric or a violation metric.

The evaluation of the rule, that is, the calculation of Expression 2 in response to the input of Expression 1, may be realized solely by a computer program, or may be realized by a trained model using artificial intelligence.

The guideline integration 221 is an integration unit that integrates the results of rule evaluations according to the guidelines 211, 212, and 21n. The guideline integration 221 calculates a violation score after integration by using an integration function for integrating the violation scores.

The integration function is represented by, for example, the following Expression 3.

$${f}_{j} ( {ϱ}_{1} , … , {ϱ}_{{n}_{s}} ) \qquad ( Expression 3 )$$

The violation score (violation score sequence) after integration is represented by, for example, the following Expression 4. Note that j=1, 2, . . . , and nᵣ.

$$\{ {f}_{1} ( {ϱ}_{1 , 1} , … , {ϱ}_{{n}_{s} , 1} ) , … , {f}_{{n}_{r}} ( {ϱ}_{1 , {n}_{r}} , … , {ϱ}_{{n}_{s} , {n}_{r}} ) \} \qquad ( Expression 4 )$$

The integration function integrates the violation score evaluated by each of the guidelines 211, 212, and 21n for the same rule. For example, a median value of the violation scores evaluated by each of the guidelines 211, 212, and 21n may be adopted as a violation score after integration. When the median value is adopted, when each of the guidelines 211, 212, and 21n outputs a clear value of 0 or 1, the violation score after integration will also be a clear value of 0 or 1, thereby preventing a driving action based on an ambiguous evaluation from being derived in a post-process driving plan. A mode, an average value, or a weighted average value evaluated by each of the guidelines 211, 212, and 21n may be adopted as the violation score after integration.

Specific Examples 1 and 2 of the calculation will be described. In Specific Example 1, a violation score for a rule is calculated from three sensor groups. It is assumed that there exists a rule that “for a certain ego-vehicle trajectory, there is no object in a path”. In this rule, each guideline outputs a violation score of 0 when it is judged that there is no object on its path, and outputs a violation score of 1 when it is judged that there is an object on its path.

It is considered a case where there is actually no object on the path, the first sensor group erroneously perceives a ghost on the path as an object, and the second and third sensor groups do not perceive the ghost on the path. In this case, the first guideline outputs a violation score of 1, and the second and third guidelines output a violation score of 0. The integration guideline adopts the median value, 0, as a violation score after integration.

It is considered a case where there is actually an object on the path, but the first sensor group cannot perceive the object due to a perception disturbance or the like, and the second sensor group and the third sensor group can perceive the object on the path. In this case, the first guideline outputs a violation score of 0, and the second and third guidelines output a violation score of 1. The integration guideline adopts the median value of 1 as the violation score after integration.

In Specific Example 2, a violation score for a rule is calculated from five sensor groups. It is assumed that there exists a rule that “a lateral distance dₗₐₜ from a stopped vehicle is set to be equal to or higher than a threshold value d₀”.

In this rule, the violation score is represented by the following Expression 5.

$$ρ = max ( 0 , {d}_{lat} - {d}_{0} ) \qquad ( Expression 5 )$$

A function of Expression 5 means that the maximum value among numerical values listed in a parentheses is adopted. A value p output by Expression 5 may be normalized to range from 0 to 1.

A case is considered in which the actual lateral distance dₗₐₜ is lower than a threshold value d₀, and only the first sensor group erroneously detects that the lateral distance dₗₐₜ is larger than the threshold value d₀. In this case, the first guideline outputs a violation score of 0, and the other second to fifth guidelines output violation scores according to their respective detection distances. The integration guideline adopts a median value as a violation score after integration, but four of the five guidelines judge that the lateral distance dₗₐₜ is lower than the threshold value d₀, although there are some errors. Therefore, the violation score after integration is the violation score indicating that the lateral distance dₗₐₜ is lower than the threshold value d₀.

The planning processor 230 plans a driving action, based on the violation score after integration output from the guideline integration 221, the set of rules stored in the rule DB 58, and the scenario data stored in the scenario DB 59.

The planning processor 230 refers to the violation score after integration, and derives a driving action that causes the vehicle 1 to avoid a violation. There may be cases where it is difficult for vehicle 1 to avoid the violation. In this case, the planning processor 230 derives a driving action that minimizes the violation score. The minimizing of the violation score may refer to a structure of a degree of priority in the set of rules.

A trajectory of the vehicle 1 is configured with a series of positions over time, over a period of the scenario. Therefore, the planning processor 230 may derive a driving action by aggregating instantaneous violation scores over time. The aggregation may be, for example, accumulating the violation scores over time. The derived driving action may depend on whether the rule is violated mildly over a long period or severely over a short period. The derived driving action may depend on at least one type of an average violation over time and a maximum violation over time.

A coincidence point and a difference point in rule evaluation among the guidelines 211, 212, and 21n will be described. In a certain method, each of the guidelines 211, 212, and 21n may be configured to evaluate multiple rules in a set of rules, which are common to each other. The configuration of evaluating the common rule is particularly appropriate to a combination with a classification that covers each direction (360 degrees) around the ego-vehicle by using one sensor group. Since the common rule is evaluated, the effect of improving evaluation accuracy by integrating each guideline is significant.

Each of the guidelines 211, 212, and 21n may be configured to evaluate only some of the rules in the set of rules, rather than evaluating all the rules stored in the rule DB 58. Further, the evaluation rules may differ partially or entirely among the guidelines 211, 212, and 21n. In this case, the rule DB 58 may additionally store information related to which the guideline 211, 212, and 21n each rule in the set of rules applies to.

In a certain guideline, when there is a rule which is not an evaluation target among rules in a rule sequence, it is advisable not to return a valid numerical value for a violation score of the rule which is not calculated in that guideline. Not returning of the valid numerical value may include returning an invalid numerical value, or not setting the numerical value itself and maintaining an initial state. For example, when the valid numerical value of the violation score is represented in a range from 0 to 1, the invalid numerical value may be a negative numerical value or a numerical value higher than 1. The initial state is, for example, a Null Value or a Null Character. When a target of integration by the guideline integration 221 includes a violation score with which a valid numerical value is not returned, by assuming that the violation score does not exist (is invalid), the guideline integration 221 calculates a violation score after integration, based only on violation score of other guidelines.

The configuration of evaluating different rules among the guidelines 211, 212, and 21n is particularly appropriate to a combination with a classification by type or a classification by direction. For example, a sensor group classified into specific sensor types is made to evaluate a rule related to an appropriate scene corresponding to the specific sensor type, and evaluation of a rule related to a non-appropriate scene is excluded. By doing so, it is possible to improve accuracy of the final evaluation of the violation score before integration.

Even when the calculation is for the same rule, an algorithm, a parameter, and the like used in the guidelines 211, 212, and 21n may be different from each other. Since a data format, a coordinate system, a dimension, a resolution, a reliability, an error, a timing delay effect, and the like of sensor data input to the guidelines 211, 212, 21n may differ for each sensor group, the algorithm, the parameter, and the like adjusted according to these factors may be adopted.

As a specific example, a case is considered in which a set of rules is common to the multiple guidelines 211, 212, and 21n. Ultrasonic sonar is appropriate for detecting an object at close range. Therefore, a guideline corresponding to a sensor group mainly having the ultrasonic sonar may be configured to be used only for calculating a violation score of a rule using an object at close range as a target, and not for calculating a violation score of a rule using an object at long range as the target. On the other hand, the communication system 43 is appropriate for detecting information over long distances or in blind spots that cannot be detected by cameras, LiDAR, ultrasonic sonar, and the like. Therefore, the guidelines corresponding to the sensor group mainly having the communication system 43 may be configured to be used for calculating a violation score of a rule using an object at long distances and in blind spots as a target, and not for calculating a violation score of other rules. That is, based on a common set of rules, each of the guidelines 211, 212, and 21n excludes some among the multiple rules included in the set of rules, which differ from each other in accordance with a difference in output source of the sensor data, from an evaluation target. In this manner, each of the guidelines 211, 212, and 21n may evaluate a rule, which is partially different from each other among the multiple rules.

### (Handling of Relevant Data)

The driving system 2 is configured to record sufficient relevant data for an accident analysis. The relevant data may include calculation-relevant data of the guideline processor 200 and the planning processor 230. The guideline processor 200 and the planning processor 230 sequentially output calculation-relevant data to the recording device 55. The recording device 55 sequentially stores the relevant data in the memory 55a.

The calculation-relevant data may include data itself of a violation score or a violation score sequence calculated in each of the guidelines 211, 212, and 21n. The calculation-relevant data may further include data of a violation score after integration or a violation score sequence associated with the violation score or the violation score sequence calculated in each of the guidelines 211, 212, and 21n.

The calculation-relevant data is data associated with data of a violation score or a violation score sequence calculated by each of the guidelines 211, 212, and 21n, which may further include sensor data based on the calculation of the violation score or the violation score sequence. When the sensor data includes data of a camera, an image captured by the camera may be recorded. When the sensor data includes LiDAR data, point cloud data representing a reflection position of reflected light may be recorded.

The calculation-relevant data is data associated with data of a violation score or a violation score sequence calculated by each of the guidelines 211, 212, and 21n, which may further include selection information of a scenario based on the calculation of the violation score or the violation score sequence.

The guideline processor 200 or another processor (for example, a processor for abnormality detection) 51b may further have a function of detecting a failure or erroneous detection of the sensor group 101, 102, and 10n, based on the calculation-relevant data. The failure or the erroneous detection of any of the sensor groups 101, 102, and 10n may be judged when an absolute value of a difference between the violation score calculated using the sensor data of the sensor group 101, 102, and 10n and the violation score after integration adopted by the guideline integration 221 is equal to or higher than a detection threshold value.

For example, a case is considered in which violation scores output corresponding to three sensor groups are 0, 0.1, and 1, respectively, and the violation score after integration is 0.1 which is a median value. When the detection threshold value is set to 0.5, the sensor group that outputs violation score 1 is judged to have a failure or erroneous detection since the absolute value of the difference is 0.8 (>0.5).

In a configuration for judging such a failure or erroneous detection, a judgement result may be associated with the violation score or the violation score sequence calculated for each guideline, and may further be recorded.

In detecting the failure or the erroneous detection, the guideline processor 200 or another processor 51b may further detect a permanent failure of the sensor group, or a temporary erroneous detection due to characteristics of the sensor group (for example, a non-appropriate scene) in a classifiable manner. For these classification results, the judgement result may be further recorded in association with the violation score or the violation score sequence calculated for each guideline.

The driving system 2 or the recording device 55 may generate, as record data, at least one type of the violation score or the violation score sequence calculated by each of the guidelines 211, 212, and 21n, the rule sequence, the violation score or the violation score sequence after integration, the sensor data of each of the sensor groups 101, 102, and 10n, the scenario selection information for each of the guidelines 211, 212, and 21n, and the judgement result of the failure or the erroneous detection of each of the sensor groups 101, 102, and 10n, to store them in a dedicated data format for recording. At this time, among the sensor groups 101, 102, and 10n related to the multiple sensor groups, only data related to a sensor group in which a failure or erroneous detection is detected may be generated and recorded.

A result of the judgement of the failure or the erroneous detection may be used for various measures other than the recording. For example, a constraint may be set such that a sensor group in which a failure or erroneous detection is detected is restricted from being used in the functions of the driving system 2 (for example, driving plan). The constraint may be set by the mode management unit 23.

For example, a notification of the presence of the sensor group 101, 102, and 10n in which a failure or erroneous detection is detected may be executed. Specifically, the driving system 2 may present information on an abnormality in the sensor groups 101, 102, and 10n to a driver, by using the HMI device 70 having an information presentation type. The driving system 2 may report the abnormality in the sensor groups 101, 102, and 10n via the communication system 43 to the external system 96, a remote center, a driving management company of the vehicle 1, a seller of the vehicle 1, a vehicle manufacturer, a sensor manufacturer, other vehicles, an administrative agency that manages a transportation infrastructure, and a third party such as a certification agency that certificates safety of automated driving systems or the like.

### (Process Flow)

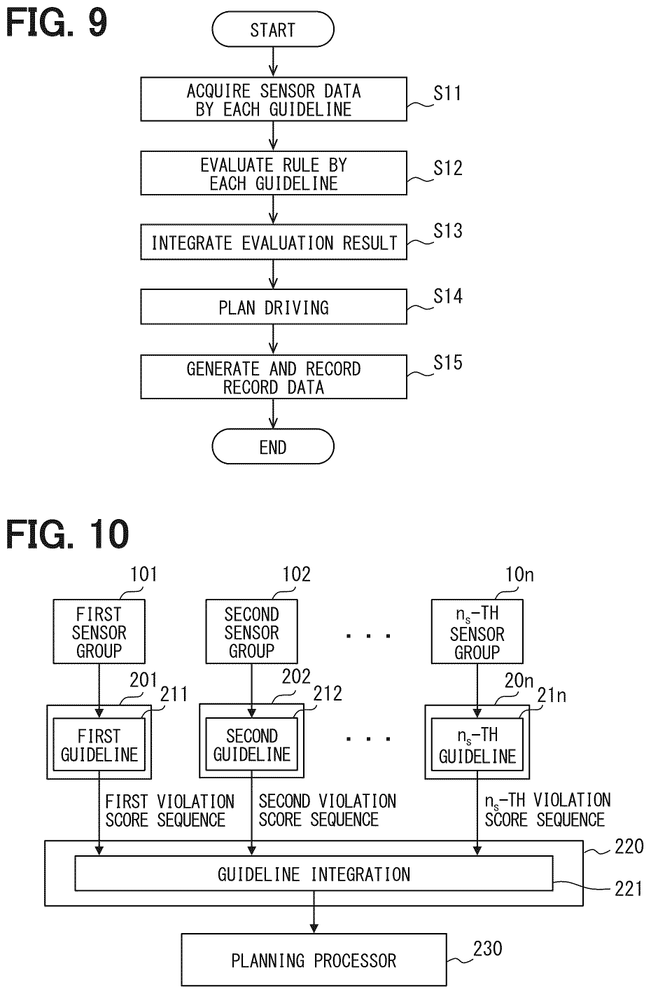

Next, an example of a processing method for realizing a driving function will be described with reference to a flowchart in FIG. 9. A series of processes illustrated in steps S11 to S15 is executed by the driving system 2 for each predetermined time or based on a predetermined trigger. As a specific example, the series of processes may be executed for each predetermined time when a mode of automated driving is managed at automated driving level 3 or higher. As another specific example, the series of processes may be executed for each predetermined time when a mode of automated driving is managed at automated driving level 2 or higher.

In S11, each of the guidelines 211, 212, and 21n acquires the latest sensor data from the sensor groups 101, 102, and 10n respectively paired with the guidelines 211, 212, and 21n. After the process in S11, the process proceeds to S12.

In S12, each of the guidelines 211, 212, and 21n acquires a rule from the rule DB 58, and evaluates the rule by using the sensor data acquired in S1. After the process in S12, the process proceeds to S13.

In S13, the guideline integration 221 integrates an evaluation result of the rule in the guidelines 211, 212, and 21n, and outputs an evaluation result after integration to the planning processor 230. After the process in S13, the process proceeds to S14.

In S14, the planning processor 230 plans a driving action of the vehicle 1, based on the evaluation result after integration. After the process in S14, the process proceeds to S15.

In S15, at least one of the guideline processor 200 and the planning processor 230 generates record data, and outputs the record data to the recording device 55. The recording device 55 stores the record data in the memory 55a. The series of processes is ended after S15.

With the first embodiment described above, evaluation related to a strategic guideline is executed individually in multiple cases by making at least some of output sources of sensor data different from each other. As this process occurs, it becomes possible to analyze a causal relationship between a final driving action and a sensor with dividing into individual evaluation results. Therefore, traceability of a planned driving action can be improved.

With the first embodiment, each of the guidelines 211, 212, and 21n outputs a matrix of violation metrics that is an individual evaluation result for a set of rules including multiple rules. By comparing matrices of multiple violation metrics that are output individually based on sensor data from at least some different output sources, it becomes easier to specify a causal relationship between the violation metric used to derive driving action and the sensor. Therefore, traceability of the driving action can be improved.

With the first embodiment, a matrix of violation metrics after integration is generated based on the matrix of multiple violation metrics output from each of the guidelines 211, 212, and 21n, and is output as the evaluation result after integration. Therefore, it is possible to derive a driving action that appropriately reflects each sensor data.

With the first embodiment, a sensor group in which a failure or erroneous detection occurs is specified, based on the matrix of each violation metric. Therefore, traceability of the driving action can be improved.

With the first embodiment, each of the guidelines 211, 212, and 21n evaluates multiple rules that are common to each other, based on a set of rules provided in common among the multiple guidelines 211, 212, and 21n. By standardizing the evaluation target, the integration process of the evaluation result can be performed easily and with high accuracy.

With the first embodiment, the guidelines 211, 212, and 21n execute evaluation for the same rule, by using different algorithms according to a difference in output source of the sensor data. In this manner, the rule evaluation can be executed appropriately for various types of sensors.

With the first embodiment, the guidelines 211, 212, and 21n execute evaluation for the same rule, by using the same algorithm and different parameters according to a difference in output source of the sensor data. In this manner, the rule evaluation can be executed appropriately according to a difference in characteristic of the output source sensor.

With the first embodiment, based on a set of rules provided in common among the multiple guidelines 211, 212, and 21n, some of the multiple rules included in the set of rules are excluded from an evaluation target in accordance with a difference in output source of the sensor data. Therefore, among the multiple rules, rules that are partially different from one another are evaluated. By executing evaluation specialized based on appropriate rules according to the difference in characteristics of the sensors as an output source, it is possible to exclude an individual evaluation result that is likely to have low accuracy. Since accuracy of the individual evaluation result is high, validity of the evaluation result after integration can be improved.

With the first embodiment, data in which the individual evaluation result is associated with the evaluation result after integration is generated and stored in the memory 55a serving as a storage medium. By storing the evaluation results together, it becomes possible to appropriately execute subsequent verification and validity check.

With the first embodiment, the multiple guidelines 211, 212, and 21n are realized by one processor 200 in common. By using the processor 200 in common, it is not necessary to integrate information such as the individual evaluation result between devices during integration, so that the integration process can be executed by restricting a delay.

In the first embodiment, the guidelines 211, 212, and 21n correspond to an individual evaluation unit. The guideline integration 221 corresponds to an integration evaluation unit.

### Second Embodiment

As illustrated in FIG. 10, a second embodiment is a modification example of the first embodiment. The second embodiment will be described focusing on a difference from the first embodiment.

The driving system 2 according to the second embodiment includes the multiple sensor groups 101, 102, and 10n, multiple guideline processors 201, 202, 20n, and 220, and the planning processor 230. The guideline processors 201, 202, 20n, and 220 are provided in a number, which is obtained by adding 1 to the total number of the sensor groups 101, 102, and 10n. The respective guideline processors 201, 202, and 20n include the individual processors 201, 202, and 20n in the same number as the number of the sensor groups 101, 102, and 10n, and one integration processor 220.

Each of the individual processors 201, 202, and 20n individually corresponds to one of the sensor groups 101, 102, and 10n. Each of the individual processors 201, 202, and 20n realizes each one of the guidelines 211, 212, and 21n using sensor data input from the sensor group 101, 102, and 10n respectively paired with the processors 201, 202, and 20n, by executing a computer program. A process of the guidelines 211, 212, and 21n has the same manner as the process of the guidelines 211, 212, and 21n in the first embodiment.

The integration processor 220 acquires violation scores or violation score sequences calculated by each of the individual processors 201, 202, and 20n, and integrates the violation scores or the violation score sequences to realize the guideline integration 221, by executing a computer program. A process of the guideline integration 221 has the same manner as the process of the guideline integration 221 in the first embodiment.

The multiple guideline processors 201, 202, 20n, and 220 and the planning processor 230 may be implemented on a common substrate. The multiple guideline processors 201, 202, 20n, and 220 and the planning processor 230 may be mounted in separate substrates. Further, the multiple individual processors 201, 202, and 20n and the integration processor 220 may be mounted on separate substrates. The multiple individual processors 201, 202, and 20n may be mounted on a common substrate, or may be mounted on separate substrates.

The rule DB 58 may be provided in common to the multiple individual processors 201, 202, and 20n. In this case, each of the individual processors 201, 202, 20n accesses the common rule DB 58, and refers to a set of rules.

On the other hand, multiple rule DBs 58 may be provided to individually correspond to each of the individual processors 201, 202, and 20n. In this configuration, the set of rules can be optimized for each of the guidelines 211, 212, and 21n. That is, it is possible to evaluate a rule appropriate to each of the sensor groups 101, 102, and 10n by an appropriate method.

With the second embodiment described above, the multiple guidelines 211, 212, and 21n are realized by the separate processors 201, 202, and 20n that individually correspond to the guidelines 211, 212, and 21n, respectively. With this, even when an abnormality occurs in some of the processors 201, 202, and 20n, the evaluation can be continued by the remaining processors. Therefore, redundancy of the processing system 50 can be improved.

### Third Embodiment

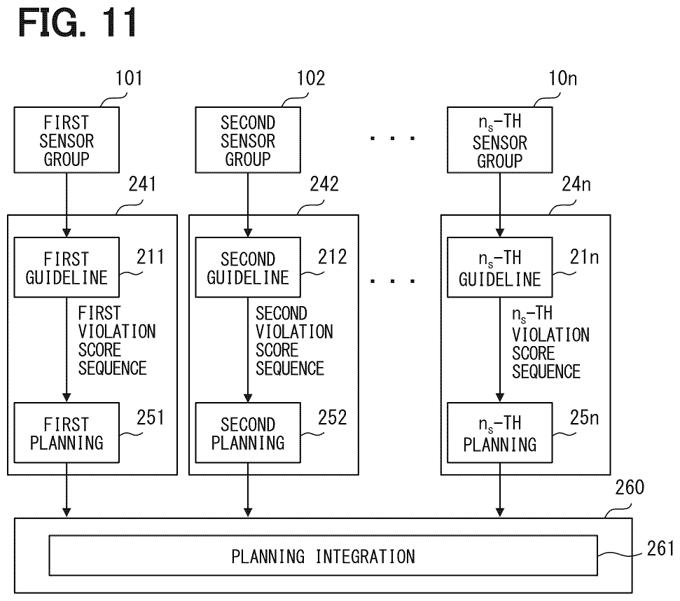

As illustrated in FIG. 11, a third embodiment is a modification example of the first embodiment. The third embodiment will be described focusing on a difference from the first embodiment.

The driving system 2 according to the second embodiment includes the multiple sensor groups 101, 102, and 10n, and multiple processors 241, 242, 24n, and 260. The multiple processors 241, 242, 24n, and 260 are provided in a number, which is obtained by adding 1 to the total number of the sensor groups 101, 102, and 10n. The respective processors 241, 242, and 24n include the individual processors 241, 242, and 24n in the same number as the number of the sensor groups 101, 102, and 10n, and one integration processor 260.

Each of the individual processors 201, 202, and 20n individually corresponds to one of the sensor groups 101, 102, and 10n. Each of the individual processors 201, 202, and 20n realizes each one of the guideline 211, 212, and 21n and each one of plannings 251, 252, and 25n using sensor data input from the sensor groups 101, 102, and 10n respectively paired with the processors 201, 202, and 20n, by executing a computer program.

Each of the plannings 251, 252, and 25n is a planner that derives a driving action capable of causing the vehicle 1 to avoid a violation or minimizing the violation, by referring to a violation score or a violation score sequence acquired from the guidelines 211, 212, and 21n respectively paired with the plannings 251, 252, and 25n.

A process of the guidelines 211, 212, and 21n has the same manner as the process of the guidelines 211, 212, and 21n in the first embodiment. On the other hand, the plannings 251, 252, and 25n are provided individually for each of the sensor groups 101, 102, and 10n and the guidelines 211, 212, and 21n. That is, each of the plannings 251, 252, and 25n derives a driving action, and outputs the driving action to the integration processor 260.

The integration processor 260 integrates the multiple driving actions derived in each of the individual processors 241, 242, and 24n into one. The integration processor 260 may determine, for example, whether to cause the vehicle 1 to change a lane, by majority vote based on the driving action derived in each of the individual processors 241, 242, and 24n.

With the third embodiment described above, evaluation related to a strategic guideline is executed multiple times individually by making at least some of output sources of the sensor data different from each other. As this process occurs, it becomes possible to analyze a causal relationship between a final driving action and a sensor with dividing into individual evaluation results. Therefore, traceability of a planned driving action can be improved.

In the third embodiment, the guidelines 211, 212, and 21n correspond to an individual evaluation unit. The processors 241, 242, and 24n correspond to an individual driving planning unit. The planning integration 261 corresponds to an integration driving planning unit.

### Fourth Embodiment

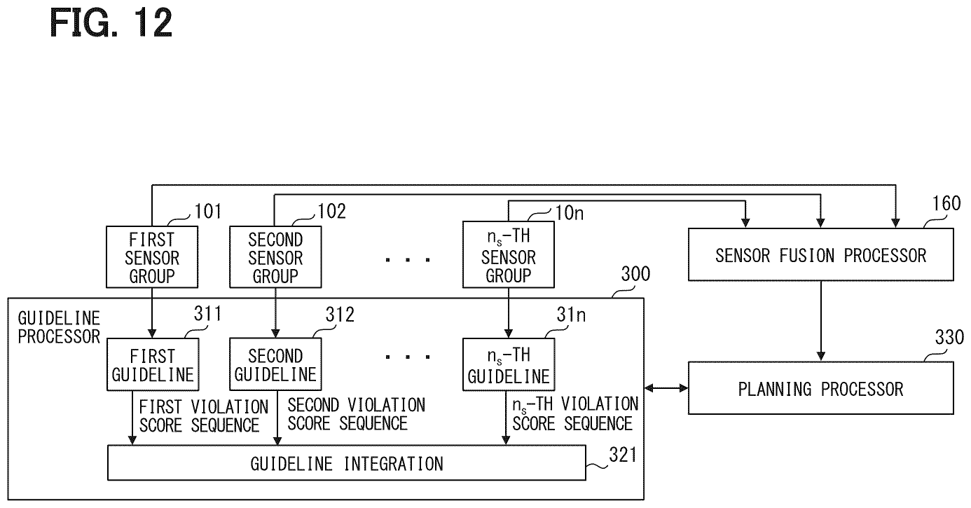

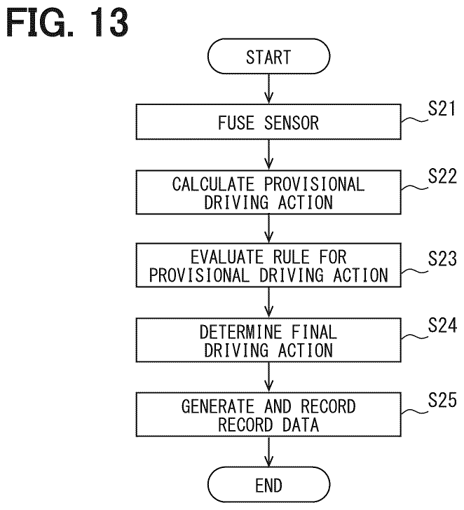

As illustrated in FIGS. 12 and 13, a fourth embodiment is a modification example of the first embodiment. The fourth embodiment will be described focusing on a difference from the first embodiment.

In the fourth embodiment, a set of rules is used to check or monitor a driving plan. The driving system 2 includes the multiple sensor groups 101, 102, and 10n, a guideline processor 300, a sensor fusion processor 160, and a planning processor 330 (see FIG. 12). A function realized by the guideline processor 300 may correspond to some of the functions of the prediction unit 21 and the driving planning unit 22. A function realized by the sensor fusion processor 160 may correspond to a part of the function of the perception unit 10. The function realized by the planning processor 330 may correspond to at least a part of the function of the driving planning unit 22.

The sensor fusion processor 160 acquires sensor data from the multiple sensor groups 101, 102, and 10n, fuses the sensor data, and generates an environment model. The planning processor 330 uses the environment model to derive a driving action. The planning processor 330 provides information on the derived provisional driving action. The provisional driving action is a candidate for a driving action to be executed.

The guideline processor 300 evaluates the driving action provided by the planning processor 330 by using a set of rules. Specifically, each of guidelines 311, 312, and 31n uses sensor data from the sensor groups 101, 102, and 10n respectively paired with the guidelines 311, 312, and 31n, the set of rules, and a scenario structure to judge whether a driving action violates a rule in the set of rules. Each of the guidelines 311, 312, and 31n outputs a violation score or a violation score sequence to the guideline integration 321, in the same manner as the first embodiment. The guideline integration 321 integrates the violation score or the violation score sequence input from each of the guidelines 311, 312, and 31n. The guideline integration 321 outputs a violation score or a violation score sequence after integration to the planning processor 330 as an evaluation result of the rule for the driving action. The planning processor 330 determines the final driving action of the vehicle 1, based on the result of this evaluation.

The planning processor 330 may cause the guideline processor 300 to compare multiple driving actions. In this case, the guideline processor 300 may calculate a separate violation score or a separate violation score sequence for each driving action, and output a performance difference between the respective driving actions to the planning processor 330, as the evaluation result.

Next, an example of a processing method for realizing a driving function will be described with reference to a flowchart in FIG. 13. A series of processes illustrated in steps S21 to S25 is executed by the driving system 2 for each predetermined time or based on a predetermined trigger. As a specific example, the series of processes may be executed for each predetermined time when a mode of automated driving is managed at automated driving level 3 or higher. As another specific example, the series of processes may be executed for each predetermined time when a mode of automated driving is managed at automated driving level 2 or higher.

In S21, the sensor fusion processor 160 fuses sensor data from the multiple sensor groups 101, 102, and 10n. After the process in S21, the process proceeds to S22.

In S22, the planning processor 330 calculates a provisional driving action. After the process in S22, the process proceeds to S23.

In S23, the guideline processor 300 evaluates a rule for the provisional driving action calculated in S22. After the process in S23, the process proceeds to S24.

In S24, the planning processor 330 refers to the evaluation result in S23, and determines the final driving action. After the process in S24, the process proceeds to S25.

In S25, at least one of the guideline processor 300 and the planning processor 330 generates record data, and outputs the record data to the recording device 55. The recording device 55 stores the record data in the memory 55a. The series of processes is ended after S25.

With the fourth embodiment described above, the guidelines 311, 312, and 31n output an individual evaluation result related to a strategic guideline for a provisional driving action. The individual evaluation result for the provisional driving action is integrated, and an evaluation result after integration is output. The final driving action is determined by referring to the evaluation result after integration of this provisional driving action. In this manner, a set of rules can be used for a monitoring function to check whether a driving plan is appropriate, thereby improving safety of the driving system 2.

In the fourth embodiment, the guidelines 311, 312, and 31n correspond to an individual evaluation unit. The guideline integration 321 corresponds to an integration evaluation unit.

### Fifth Embodiment

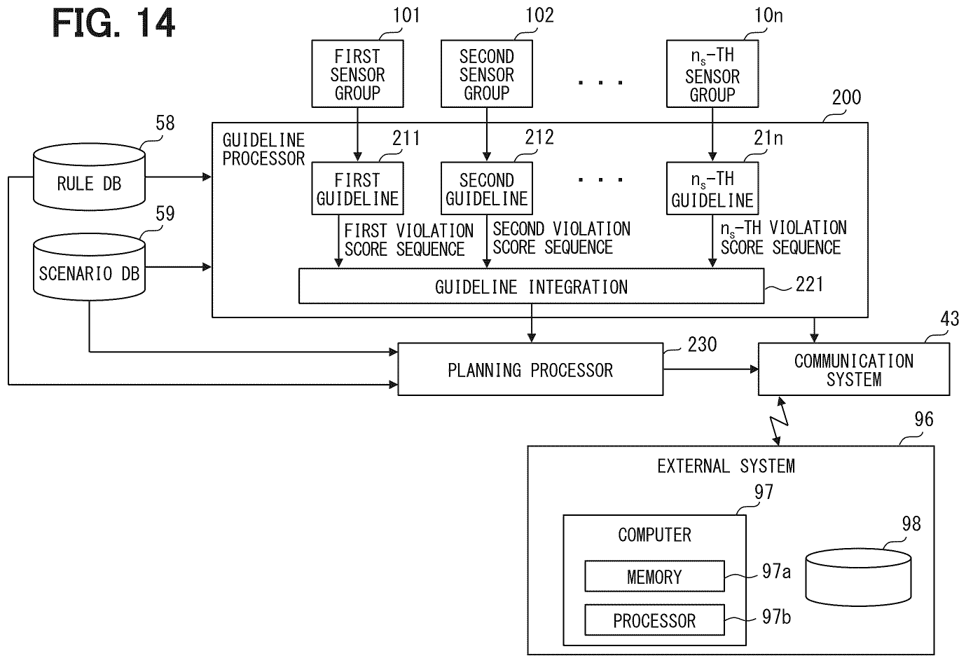

As illustrated in FIG. 14, a fifth embodiment is a modification example of the first embodiment. The fifth embodiment will be described focusing on a difference from the first embodiment.

In the fifth embodiment, generated record data (for example, relevant data related to accident verification) may be transmitted to the external system 96 by communication through the communication system 43 (for example, V2X communication) and stored in a storage medium 98 of the external system 96. In the transmitting to the external system 96, the record data may be generated and transmitted as encoded data to conform to a specific format, such as a safety driving model (SDM) message. The transmission to the external system 96 does not have to be a direct transmission of radio waves from the vehicle 1 to the external system 96, but may be a transmission using a relay terminal such as a roadside device and a network.

The external system 96 includes a dedicated computer 97 having at least one memory 97a and one processor 97b, and at least one mass storage medium 98. In the dedicated computer 97, the memory 97a may be at least one type of non-transitory tangible storage medium, such as a semiconductor memory, a magnetic medium, an optical medium, and the like, which non-temporarily stores a program, data, and the like that can be read by the processor 97b. Further, for example, a rewritable volatile storage medium such as a random access memory (RAM) may be provided as the memory 97a. The processor 97b includes, for example, at least one type of a central processing unit (CPU), a graphics processing unit (GPU), a reduced instruction set computer (RISC)-CPU, and the like, as a core. The storage medium 98 may be at least one type of non-transitory tangible storage medium among, for example, a semiconductor memory, a magnetic medium, and an optical medium.

The external system 96 decodes the received message. The external system 96 may then sequentially record the record data in a memory region secured in the storage medium 98 for each one vehicle. The external system 96 may collect record data for a large number of vehicles traveling on a road, and sequentially record the record data in a common memory region.

The accumulated data may be used as big data for developing a road network. For example, the external system 96 specifies a location at which an accident frequently occurs from the accumulated data, and further specifies a rule that is frequently violated at the location at which the accident frequently occurs. Therefore, it is possible to improve a road structure at the accident-frequent location such that a violation of the specified rule is less likely to occur.

The accumulated data may be used for verification and a validation check of the driving system 2 or its underlying safety model to enable an efficient SOTIF process. For example, the driving system 2 can be improved by analyzing a causal relationship between the sensor data, the violation score calculated based on the sensor data, and the driving action of the vehicle 1. The improvement of the driving system 2 includes at least one type of improvement of the rule evaluation algorithm and improvement of the set of rules. The improvement of the set of rules includes at least one type of changing the rule itself and changing a structure of a degree of priority.

With the fifth embodiment described above, data is generated, in which the individual evaluation result is associated with the evaluation result after integration. This data is transmitted to the external system 96 existing outside the vehicle 1 via the communication system 43 mounted in the vehicle 1. By collecting the evaluation result and transmitting the evaluation result to the outside, even when the data stored in the vehicle 1 is damaged due to an accident or the like, subsequent verification and validity check can be easily performed. It becomes easy for the external system 96 to integrate and utilize data from multiple vehicles.

### Other Embodiments

Although multiple embodiments are described above, the present disclosure is not construed as being limited to these embodiments, and can be applied to various embodiments and combinations within a scope that does not depart from the gist of the present disclosure.

As another embodiment, the record data of the second to fourth embodiments may be transmitted to the external system 96 by communication through the communication system 43 (for example, V2X communication), and stored in the storage medium 98 of the external system 96, in the same manner as the fifth embodiment.

In still another embodiment, the guideline processor 200, the rule DB 58, and the scenario DB 59 may be mounted in a vehicle that travels by manual driving by a driver. For example, a violation score or a violation score sequence output by the guideline processor 200 may be recorded as record data by the recording device 55, and the record data may be used to evaluate manual driving.

For example, the rule evaluation result by the guideline processor 200 may be presented as information by the HMI device 70 having an information presentation type to a driver who is manually driving the vehicle. In this example, the presentation of information on a rule having a violation score of 0 may be omitted, and only information on a rule having a violation score equal to or higher than a predetermined threshold value may be presented. The threshold value may be 0.5 or 1. In this manner, it is advisable to select a rule violation for which information is to be presented, taking into consideration the annoyance felt by the driver.

The control unit and the method thereof described in the present disclosure may be realized by a dedicated computer constituting a processor programmed to execute one or multiple functions embodied by a computer program. Alternatively, a device and its method according to the present disclosure may be realized by a dedicated hardware logic circuit. Alternatively, the device and its method according to the present disclosure may be realized by one or more dedicated computers including a combination of a processor executing a computer program and one or more hardware logic circuits. The computer program may be stored in a computer-readable non-transitory tangible storage medium, as an instruction executed by a computer.

### Description of Terms

Terms related to the present disclosure will be described below. This description is included in the embodiments of the present disclosure.

A road user may be a human who uses a road including a sidewalk and other adjacent spaces. The road user may include a pedestrian, a cyclist, other VRUs, and a vehicle (for example, an automobile driven by a human or a vehicle equipped with an automated driving system).

A dynamic driving task (DDT) may be a real-time operation function and a real-time strategic function for operating a vehicle in traffic.

An automated driving system may be a set of hardware and software capable of continuously executing all DDTs regardless of whether a limitation to a specific operational design domain is present.

Safety of the intended functionality (SOTIF) may mean absence of an unreasonable risk caused by functional insufficiency for an intended function or its implementation.

A driving policy may be a strategy and a rule defining a control action at a vehicle level.

A safety-relevant object may be any moving or static object that may be relevant to the safety performance of the DDT.

A scenario may be a depiction of the temporal relationships between several scenes in a series of scenes, including goals and values in a particular situation influenced by actions and events. The scenario may be a depiction of consecutive activities in time series in which a vehicle as a main-object, its all external environments, and their interactions in a process of executing a specific driving task are integrated.

A triggering condition may be a specific condition of a scenario functioning as a trigger for a response that is a response of a subsequent system and that contributes to inability to prevent, detect, and reduce hazardous behavior and reasonably predictable indirect misuse.

A strategic guideline may be at least one condition and at least one appropriate driving action associated with the condition. The strategic guideline is used broadly to denote any expression, explanation, description, depiction, or logical relationship derived from one or more basic principles. A strategic guideline may be synonymous with a logical expression.

A hazardous situation may be an increased risk for a potential violation of the safety envelope and also represents an increased risk level existing in the DDT.

A safety envelope may be a set of a constraint and a condition that are designed for a (automated) driving system to operate as a target for a constraint or a control in order to maintain an operation at an allowable risk level. The safety envelope may be a general concept that can be used to deal with all principles on which the driving policy can be based. According to this concept, an ego-vehicle operated by the (automated) driving system can have one or multiple boundaries around the ego-vehicle.

### Disclosure of Technical Ideas

The present disclosure also describes the following several technical ideas.

### Technical Idea

A processing system that executes a process related to driving of a vehicle includes:
a guideline processor; and
a planning processor.

The guideline processor realizes:
multiple guideline functions of outputting individual evaluation results related to a strategic guideline based on sensor data, in which at least some of output sources of the sensor data are different from each other; and
a guideline integration function of integrating each of the individual evaluation results and outputting an evaluation result after integration.

The planning processor outputs a driving action plan in response to an input of the evaluation result after integration.

With this technical idea, it is possible to improve traceability of the planned driving action.

### Technical Idea

A processing system that executes a process related to driving of a vehicle includes:
multiple guideline processors; and
a planning processor.

The multiple guideline processors includes:
an individual processor that realizes each of multiple guideline functions of outputting individual evaluation results related to a strategic guideline based on sensor data, in which at least some of output sources of the sensor data are different from each other between the multiple guideline processors; and
an integration processor that realizes a guideline integration function of integrating each of the individual evaluation results and outputting an evaluation result after integration.

The planning processor outputs a driving action plan in response to an input of the evaluation result after integration.

With this technical idea, it is possible to improve traceability of the planned driving action.

### Technical Idea

A processing system that executes a process related to driving of a vehicle includes:
multiple individual processors; and
an integration processor.

Each of the individual processors realizes:
multiple guideline functions of outputting individual evaluation results related to a strategic guideline based on sensor data, in which at least some of output sources of the sensor data are different from each other between the multiple individual processors, and
an individual planning function of outputting an individual driving action plan based on the individual evaluation result.

The integration processor integrates each of the individual driving actions and outputs a driving action plan after integration.

With this technical idea, it is possible to improve traceability of the planned driving action.

### Technical Idea

A method for executing a process related to a vehicle by at least one processor includes:
acquiring individual sensor data from each of multiple sensor groups;
executing each individual evaluation related to a strategic guideline in parallel, based on the individual sensor data; and
integrating a result of each of the individual evaluations and outputting an evaluation result after integration.

With this technical idea, it is possible to improve traceability in the process related to the vehicle.

### Technical Idea

A method for executing a process related to a vehicle by at least one processor includes:
specifying an unknown scenario which the vehicle encounters, by referring to a scenario structure stored in a scenario database; and
evaluating, based on a set of rules stored in a rule database and a result of the specifying, a rule defined in the set of rules, in the unknown scenario.

With this technical idea, it is possible to provide a feedback on the unknown scenario which the vehicle encounters.

### Technical Idea

A method for executing a process related to a vehicle by at least one processor includes:
specifying an unknown scenario which the vehicle encounters, by referring to a scenario structure stored in a scenario database; and
specifying, based on a set of rules stored in a rule database and a result of the specifying, a rule which the vehicle has difficulty following, among rules defined in the set of rules, in the unknown scenario.

With this technical idea, it is possible to provide a feedback on the unknown scenario which the vehicle encounters.

### Technical Idea

A storage medium for storing data related to a driving action of a vehicle stores:
a value of a violation metric associated with a driving action which violates a rule statement defined in a set of rules; and
sensor data used to calculate the violation metric, in association with each other.

With this technical idea, it is possible to improve traceability of the driving action of the vehicle.

### Technical Idea

A method for generating data related to a driving action of a vehicle by at least one processor includes:
calculating a value of a violation metric associated with a driving action which violates a rule statement defined in a set of rules, by using sensor data; and
generating data to be stored in a dedicated data format such that the value of the violation metric is associated with the sensor data used to calculate the violation metric.

With this technical idea, it is possible to improve traceability of the driving action of the vehicle.

### Technical Idea

A storage medium for storing data related to a driving action of a vehicle stores:
values of multiple violation metrics associated with a driving action which violates a rule statement defined in a set of rules, the value of the violation metric being calculated by using each sensor data, in which at least some of output sources of the sensor data are different from each other; and
a value of a violation metric after integration obtained by integrating the values of the multiple violation metrics, in association with each other.

With this technical idea, it is possible to improve traceability of the driving action of the vehicle.

### Technical Idea

A method for generating data related to a driving action of a vehicle by at least one processor includes:
calculating values of multiple violation metrics associated with a driving action which violates a rule statement defined in a set of rules, the value of the violation metric being calculated by using each sensor data, in which at least some of output sources of the sensor data are different from each other;
calculating a violation metric value after integration by integrating the values of the multiple violation metrics; and
generating data to be stored in a dedicated data format such that the values of the multiple violation metrics before integration are associated with the value of the violation metric after integration.

With this technical idea, it is possible to improve traceability of the driving action of the vehicle.

### Technical Idea

A system for integrating information from multiple vehicles includes:
at least one processor; and
at least one storage medium.

The at least one processor is configured to:
receive a message which is transmitted from the vehicle, and which includes a value of a violation metric associated with a driving action which violates a rule statement defined in a set of rules and sensor data used to calculate the violation metric, and
accumulate the value of the violation metric and the sensor data in the at least one storage medium.

With this technical idea, it is possible to improve traceability of the driving action of the vehicle.

### Technical Idea

A driving system for executing a dynamic driving task of a vehicle includes:
multiple sensor groups which are configured by classifying multiple sensors provided in the vehicle and each of which provides sensor data;
a rule database that stores a set of rules which implements a structure of a degree of priority in a series of rules arranged based on a relative importance;
a scenario database that stores a scenario structure including multiple scenarios indicating the vehicle, an external environment, and an interaction between the vehicle and the external environment, in a process of executing the dynamic driving task;
at least one processor; and
at least one storage medium.

The at least one processor is configured to:
acquire the sensor data from each of the sensor groups,
acquire the set of rules by accessing the rule database,
acquire the scenario structure by accessing the scenario database,
calculate multiple violation scores for the rule, the violation score being calculated by using each sensor data from the different sensor groups which are output sources, based on the sensor data, the set of rules, and the scenario structure,
calculate a violation score after integration by integrating the multiple violation scores,
execute the dynamic driving task based on the violation score after integration, and
record the multiple violation scores before integration in the at least one storage medium.

With this technical idea, it is possible to improve traceability of the driving system.

### Technical Idea

A driving method of a vehicle for executing a dynamic driving task of a vehicle includes:
acquiring sensor data provided from each of multiple sensor groups configured by classifying multiple sensors provided in the vehicle;
acquiring a set of rules which implements a structure of a degree of priority in a series of rules arranged based on a relative importance, from a rule database;
acquiring a scenario structure including multiple scenarios indicating the vehicle, an external environment, and an interaction between the vehicle and the external environment, in a process of executing the dynamic driving task, from a scenario database;
calculating multiple violation scores for the rule, the violation score being calculated by using each sensor data from the different sensor groups which are output sources, based on the sensor data, the set of rules, and the scenario structure;
calculating a violation score after integration by integrating the multiple violation scores;
executing the dynamic driving task based on the violation score after integration; and
recording the multiple violation scores before integration in at least one storage medium.

With this technical idea, it is possible to improve traceability for execution of the dynamic driving task of the vehicle.

### Technical Idea

A method for generating an individual evaluation result related to a strategic guideline includes:
acquiring sensor data from multiple sensor groups provided in a vehicle;
generating each matrix of a violation metric, which is an individual evaluation result for a set of rules including multiple rules, by an individual evaluation unit provided corresponding to each sensor group, based on the sensor data acquired from each sensor group;
generating a matrix of a violation metric after integration, which is an evaluation result after integration, based on the matrix of the violation metric calculated by each individual evaluation unit; and
recording the matrix of the individual violation metric in a storage medium.

With this technical idea, it is possible to improve traceability of the evaluation result related to the strategic guideline.

What is claimed is:

1. A processing system that executes a process related to driving of a vehicle, the processing system comprising:
a plurality of individual evaluation units configured to output individual evaluation results related to a strategic guideline based on sensor data, in which at least some of output sources of the sensor data are different from each other;
an integration evaluation unit configured to integrate each of the individual evaluation results, and output an evaluation result after integration; and
a driving planning unit configured to plan a driving action based on the evaluation result after the integration.

2. The processing system according to claim 1, wherein
each of the individual evaluation units outputs a matrix of a violation metric which is an individual evaluation result for a set of rules including a plurality of rules.

3. The processing system according to claim 2, wherein
the integration evaluation unit generates a matrix of a violation metric after integration based on the matrix of a plurality of violation metrics output from each of the individual evaluation units, and outputs the matrix as the evaluation result after the integration.

4. The processing system according to claim 3, wherein
an output source of the sensor data in which a failure or erroneous detection occurs is specified based on the matrix of each of the violation metrics.

5. The processing system according to claim 2, wherein
the set of rules is provided in common among the plurality of individual evaluation units, and
each of the individual evaluation units evaluates the plurality of rules in common to each other, based on the set of rules.

6. The processing system according to claim 5, wherein
each of the individual evaluation units executes evaluation on same rule, by using a different algorithm according to a difference in output source of the sensor data.

7. The processing system according to claim 5, wherein
each of the individual evaluation units executes evaluation on same rule, by using same algorithm and a different parameter according to a difference in output source of the sensor data.

8. The processing system according to claim 2, wherein
the set of rules is provided in common among the plurality of individual evaluation units, and
each of the individual evaluation units evaluates the rules that partially differ from each other among the plurality of rules, by excluding a part of the plurality of rules included in the set of rules from an evaluation target in accordance with a difference in output source of the sensor data, based on the set of rules.

9. The processing system according to claim 1, wherein
data in which an individual evaluation result is associated with the evaluation result after the integration is generated, and stored in a storage medium.

10. The processing system according to claim 1, wherein
data in which an individual evaluation result is associated with the evaluation result after the integration is generated, and transmitted to an external system existing outside the vehicle through a communication system mounted in the vehicle.

11. The processing system according to claim 1, wherein
the plurality of individual evaluation units are implemented by one processor in common.

12. The processing system according to claim 1, wherein
the plurality of individual evaluation units are implemented by separate processors each individually corresponding to the individual evaluation unit.

13. The processing system according to claim 1, wherein
the driving planning unit derives a provisional driving action,
the individual evaluation unit outputs an individual evaluation result related to the strategic guideline for the provisional driving action,
the integration evaluation unit integrates each of the individual evaluation results for the provisional driving action and outputs an evaluation result after the integration, and
the driving planning unit determines a final driving action by referring to the evaluation result after the integration for the provisional driving action.

14. A processing system that executes a process related to driving of a vehicle, the processing system comprising:
a plurality of individual evaluation units configured to output individual evaluation results related to a strategic guideline based on sensor data, in which at least some of output sources of the sensor data are different from each other;
a plurality of individual driving planning units that are provided to individually correspond to each of the individual evaluation units and configured to plan individual driving actions based on an individual evaluation result output by the individual evaluation unit paired with an individual driving planning unit; and
an integration driving planning unit configured to integrate each of the individual driving actions and plan a driving action after the integration.

15. A method for executing a process related to driving of a vehicle, the method comprising:
outputting individual evaluation results related to a strategic guideline based on sensor data, wherein at least some of output sources of the sensor data are different from each other;
integrating each of the individual evaluation results;
outputting an evaluation result after integration; and
planning a driving action based on the evaluation result after the integration.
